(19) United States
(12) Patent Application Publication
(10) Pub. No.: US 2014/0045699 A1
(43) Pub. Date: Feb. 13, 2014

(54) STIMULUS-RESPONSIVE POLYMERIC PARTICLE FORMULATIONS

(71) Applicants: Andrew Michael Howe, Cambridge (GB); Stephanie Vronique Desrousseaux, Cambridge (GB); Marie-Capucine Pope, Rennes (FR)

(72) Inventors: Andrew Michael Howe, Cambridge (GB); Stephanie Vronique Desrousseaux, Cambridge (GB); Marie-Capucine Pope, Rennes (FR)

(21) Appl. No.: 14/113,267

(22) PCT Filed: Apr. 25, 2012
(86) PCT No.: PCT/US2012/034878

§ 371 Date: Oct. 22, 2013

(30) Foreign Application Priority Data
Apr. 26, 2011 (GB) 1106866.5

(51) Int. Cl. C08K 3/22

(52) U.S. Cl. CPC C08K 3/22
USPC 504/361; 524/401; 71/27; 514/772.6

(57) ABSTRACT

A stimulus-responsive formulation of stimulus-responsive polymer particles in aqueous composition has a rheology-stimulus profile (e.g. rheology-temperature) whereby it exhibits certain rheological behaviours over a range of temperatures, which is controllable by copolymerising a stimulus-responsive polymer-forming monomer, such as N-isopropylacrylamide, with a certain proportion of second monomer having weak acid functionality (such as acrylic acid) to form the stimulus-responsive microgel particles of the formulation and by addition of a base to the formulation to neutralise a portion but not all of the weak acid functionality. Thus a stimulus-responsive formulation may be controlled to exhibit gel-to-liquid-to-gel like behaviour with increasing temperature.

### FIELD OF THE INVENTION

The present invention relates to formulations/compositions of stimulus-responsive particle aqueous dispersions having desirable rheology-to-stimulus range profiles and to methods of controlling the rheology of a formulation over a stimulus range. The invention further relates to temperature-responsive formulations having desirable rheology-thermal profiles.

### BACKGROUND OF THE INVENTION

Cross-linked, water-swellable, stimulus-responsive particles, such as ‘microgels’, have been the subject of extensive studies that take advantage of the switchable properties of such materials. The unique feature of these hydrophilic ‘microgels’ is that swelling with water and all related properties are very sensitive to an external stimulus, such as temperature. For example, the particle volume can typically decrease by a factor of ten when the temperature is changed from typical room temperature to 40° C. and the particle nature changes from being highly hydrophilic to highly hydrophobic. This latter property switch is particularly pertinent because the stability of aqueous, hydrophobic particle dispersions is much worse than that of aqueous hydrophilic dispersions.

The synthesis used to make such materials is a typical emulsion polymerization reaction, wherein the required monomer is reacted with a cross-linking agent, and optionally a surfactant, in an aqueous solution from which oxygen has been purged, with stirring. After heating, polymerization is initiated by addition of a polymerization initiator. The formed polymer is insoluble in the reaction medium and forms particles. The mixture is stirred, in the absence of oxygen to the required temperature for a number of hours, typically 5 hours, until the polymerization is complete, after which the heating is switched off and the mixture left to cool down to room temperature. The reaction yields a dispersion which is then purified by, for example, dialysis.

The responsive nature of the particles is derived from the properties of a primary monomer or monomers such as poly (N-isopropylacrylamide). However, it is known that the incorporation of a co-monomer can influence the temperature or pH at which the particle undergoes a transition from a swollen to a collapsed state, or vice versa. For instance, Gao and Frisken (Gao J. and Frisken B. J, Langmuir, 2005, 21 (2), 545-551) have shown how incorporation of monomers such as styrene, methyl methacrylate and acrylic acid affect particle swelling and breadth of the phase transition. Tang et al (Ma X., Xi J., Zhao X. and Tang X., Journal of Polymer Science, Part B: Polymer Physics, (2005), 43(24), 3575-3583) investigated how the volume-phase transition temperature is affected by the incorporation of ethylene glycol containing monomers.

Polymeric compounds can be made in several forms. For example, hydrogels are water-swollen networks (cross-linked structures) of hydrophilic homopolymers or copolymers. They are three-dimensional and the cross-links can be formed by covalent or ionic bonds (‘Preparation methods and structure of Hydrogels’, N. A. Peppas, A. G. Mikos, Hydrogels in medicine and pharmacy, Volume I Fundamentals, Ed. N. A. Peppas, Chapter 1, 1-25 (1985)).

Microgels as described by Baker (W. O. Baker, ‘Microgel, a new macromolecule’, Ind Eng Chem 41 (1949) 511-520) were defined as a new architecture for polymer particles that comprises cross-linked hydrophobic latex particles which swell in organic solvents to form colloidally dispersed gel particles. Over the last 20 years, interest has grown in hydrophilic microgels, i.e. cross-linked hydrophilic polymers, which swell in water. These microgels, as prepared in accordance with this invention, are intermediate between branched and macroscopically-cross-linked polymers and can best be described as (typically) having a narrow size distribution, and being spherical particles with average diameters from 50 nm to 5 μm (Current Opinions in Colloid and Interface Science, 13 (2008) 413-428).

The IUPAC definition of ‘latex’ is an emulsion or sol in which each colloidal particle contains a number of macromolecules (Chapter 1, Les latex synthétiques, Lavoisier 2006). Practically, academic and industry scientists working in the field consider a synthetic latex to be a colloidal dispersion of particles composed of macromolecules, usually an aqueous dispersion. However, hydrophilic microgels are cross-linked polymers that have the capability to swell in water, which many latexes cannot do (being dispersed insoluble polymer particles). A particle composition comprising a dispersion of stimulus-responsive particles in a ‘solvent’, e.g. water, may be termed a microgel (an aqueous or hydrophilic microgel, as mentioned above, being capable of a swollen state in water). Such microgels have two states, one in which the solvent (e.g. water) is a good solvent under the conditions whereby the particles occupy a swollen state and another, in which the solvent is a poor solvent for the polymer under the conditions, whereby the polymer particles occupy a collapsed state. Typically, the particle composition switches between the two states when conditions change such that the conditions transition from poor solvent to good solvent conditions. In either state, a polymer particle composition capable of such a transition may be termed a microgel.

Stimulus-responsive aqueous microgel formulations find application and potential application in a number of different technologies, from printing to paints to drug delivery, where advantage is taken of the switchable nature of the material transitioning from collapsed (hydrophobic) state to swollen (hydrophilic) state.

WO-A-2008/075049 describes an aqueous inkjet fluid comprising a functional component (e.g. a colorant such as a pigment) and a plurality of discrete polymeric particles dispersed in aqueous medium to form a microgel composition switchable between a collapsed state (which allows passage of the particles through an inkjet head) and a swollen state which is of higher viscosity thus allowing immobilization of ink droplets on a substrate.

US-A-2011/041715 describes a flexographic printing ink comprising microgel particles which improve printing performance onto low-energy surface or impermeable substrates by improving adhesion of the printed composition on the substrate. WO-A-2011/022046 describes the use of a monodisperse aqueous composition of discrete stimulus-responsive particles applied to a substrate to produce pre-determined patterns of self-ordered particles and unordered particles (utilizing the switching behavior) to produce selective structural colour on a substrate.

For many applications, including printing, it is desirable to be able to control the rheology of a stimulus responsive aqueous microgel over a stimulus range (e.g. a temperature range) in order to have flexibility and predictability of processing parameters over the stimulus (e.g. temperature range). For printing and other applications where water management is desirable, it would be beneficial to provide a an aqueous stimulus responsive polymer particle composition which not only had a desired ‘switching’ function but has controllable rheological properties at higher or lower temperatures whereby specific process requirements can be met. For example, in printing, it may be desirable to have an ink that has low viscosity (liquid like properties) for a printing step, but gels at higher temperature to enable rapid removal of water without the problems of coalescence etc affecting image quality. For drug delivery formulations, it may be desirable for example, to be able to store the formulation at low temperature (as may be required for the drug) without the drug and the particulates precipitating, whilst enabling administration of the formulation at room temperature.

### PROBLEM TO BE SOLVED BY THE INVENTION

Accordingly, it is an object of the invention to provide a method for controlling the rheology-stimulus profile of a stimulus-responsive formulation comprising an aqueous dispersion of discrete stimulus-responsive crosslinked polymer particles.

It is further an object of the invention to provide an aqueous stimulus-responsive formulation of discrete stimulus-responsive crosslinked polymeric particles, which is controlled to have a desired rheology-stimulus profile (such as a rheology-temperature profile).

It is a further object of the invention to provide an aqueous stimulus-responsive formulation of discrete stimulus-responsive crosslinked polymeric particles which provides a switching function, enables processibility under process conditions and provides useful and controllable rheological properties outside the process condition range.

### SUMMARY OF THE INVENTION

According to a first aspect of the invention, there is provided a stimulus-responsive formulation comprising an aqueous dispersion or suspension of discrete stimulus-responsive crosslinked polymeric particles in aqueous medium, the polymeric particles comprising a co-polymer of at least a first stimulus-responsive polymer-forming monomer and a second polymer-forming monomer having a weak acid functionality, the formulation further comprising an acid-neutralising agent or pH adjustment agent in an amount to neutralize a portion of the weak acid functionality of the polymeric particles.

In a second aspect of the invention, there is provided a method of controlling the rheological-stimulus profile of a stimulus-responsive formulation comprising an aqueous dispersion or suspension of discrete stimulus-responsive crosslinked polymeric particles in aqueous medium, which polymer particles comprise at least a first stimulus-responsive polymer-forming monomer, the method comprising co-polymerising with the first stimulus-responsive polymer-forming monomer a second polymer-forming monomer having weak acid functionality.

### ADVANTAGEOUS EFFECT OF THE INVENTION

The method and formulation of the present invention enable the rheological profile to be controlled to suit certain processing steps and applications. In particular, the surprising finding that controlling the relative proportion of weak acid-containing monomer in a crosslinked stimulus-responsive discrete polymer particle (and optionally controlling the relative proportion of weak acid functionality that is neutralised in a resulting aqueous formulation) enabled certain rheological behaviours to be controlled along a stimulus (e.g. temperature) range, allows beneficial rheological profiles to be controlled in order to meet certain process and/or functional requirements of a stimulus-responsive formulation. For example, by controlling the proportion of weak acid-containing monomer in the polymer particles and by controlling the proportion of weak acid functionality neutralised, a formulation of the stimulus-responsive polymer particles can be controlled to have a gel to liquid to gel rheological profile with increasing temperature.

### BRIEF DESCRIPTION OF THE DRAWINGS

FIG. 1 is a graph of viscosity (Pa·s) versus temperature (° C.) at low stress (0.04 Pa) of a comparative formulation (P1 microgel);

FIG. 2 is a graph of viscosity against applied stress (Pa) at various temperatures of a comparative formulation (P1 microgel);

FIG. 3 is a graph of storage modulus (G′) and loss modulus (G″) against applied stress (Pa) of a comparative formulation (P1 microgel) in oscillatory shear flow at 1 rad·s⁻¹;

FIG. 4 is a graph of complex modulus (G*) and phase angle (δ) against applied stress (Pa) of a comparative formulation (P1 microgel) in oscillatory shear flow at 1 rad·s⁻¹ and at different temperatures;

FIG. 5 is a graph of complex modulus (G*) and phase angle (δ) against frequency of a comparative formulation (P1 microgel) in oscillatory shear flow with stress controlled to give a strain of 0.01;

FIG. 6 is a graph of viscosity (Pa·s) versus temperature (° C.) at low stress (0.04 Pa) of a comparative formulation (P2 microgel) at 4 wt % without any weak acid monomer;

FIG. 7 is a graph of viscosity against applied stress (Pa) at various temperatures of a comparative formulation (P2 microgel);

FIG. 8 is a graph of storage modulus (G′) and loss modulus (G″) against applied stress (Pa) of a comparative formulation (P2 microgel) in oscillatory shear flow at 1 rad·s⁻¹;

FIG. 9 is a graph of complex modulus (G*) and phase angle (δ) against applied stress (Pa) of a comparative formulation (P2 microgel) in oscillatory shear flow at 1 rad·s⁻¹ and at different temperatures;

FIG. 10 is a graph of viscosity (Pa·s) versus temperature (° C.) at low stress (0.01 Pa) of a comparative formulation (P3 linear polymer) at 4 wt % without any weak acid monomer at 4 wt %;

FIG. 11 is a graph of viscosity (Pa·s) versus temperature (° C.) at low stress (0.01 Pa) of a formulation used in the invention (A1 microgel) at 4 wt %;

FIG. 12 is a graph of viscosity against applied stress (Pa) at various temperatures of a formulation used in the invention (A1 microgel);

FIG. 13 is a graph of complex modulus (G*) and phase angle (δ) against applied stress (Pa) of a formulation used in the invention (A1 microgel) in oscillatory shear flow at 1 rad·s⁻¹ and at different temperatures;

FIG. 14 is a graph of complex modulus (G*) against temperature of a formulation used in the invention (A1 microgel) in oscillatory shear flow at 1 rad·s⁻¹ and low stress (0.04 or 0.003) at varying concentrations of base;

FIG. 15 is a graph of phase angle (δ) against temperature of a formulation used in the invention (A1 microgel) in oscillatory shear flow at 1 rad·s⁻¹ and low stress at different concentrations of base;

FIG. 16 is a graph of viscosity at low stress (0.04 Pa) against temperature (heating cycle) of a formulation used in the invention (A1 microgel) at 2 wt % and different concentrations of base;

FIG. 17 is a graph of viscosity at low stress (0.04 Pa) against temperature (cooling cycle) of a formulation used in the invention (A1 microgel) at different concentrations of base;

FIG. 18 is a graph of complex modulus (G*) and phase angle against temperature of a formulation used in the invention (A1 microgel) in oscillatory shear flow at 1 rad·s⁻¹ and low stress (0.04);

FIG. 19 is a graph of complex modulus (G*) against applied stress (Pa) of a formulation used in the invention (A1 microgel) in oscillatory shear flow at 1 rad·s⁻¹ at various temperatures;

FIG. 20 is a graph of phase angle against applied stress of a formulation used in the invention (A1 microgel) with 10 mM base in oscillatory shear flow at 1 rad·s⁻¹ at various temperatures;

FIG. 21 is a graph of viscosity against applied stress of a formulation used in the invention (A1 microgel) at 25° C.;

FIG. 22 is a graph of viscosity against temperatures for a formulation used in the invention (using B1 microgel);

FIG. 23 is a graph of complex modulus and phase angle versus temperature for the formulation used in the invention (using B1 microgel) in oscillatory shear flow at 1 rad·s⁻¹;

FIG. 24 is a graph of viscosity versus temperature for a formulation used in the invention (using B1 microgel);

FIG. 25 is a graph of complex modulus and phase angle versus temperature for a formulation used in the invention (using B1 microgel);

FIG. 26 is a graph of viscosity versus temperature for a formulation used in the invention (using C3 microgel);

FIG. 27 is a graph of viscosity against temperature for a formulation used in the invention (using C3 microgel) at varying concentrations of base;

FIG. 28 is a graph of viscosity against temperature for a formulation used in the invention (using microgels C1, C3 and C3);

FIG. 29 is a graph of viscosity against temperature for a formulation used in the invention (using microgels C1, C2 and C3);

FIG. 30 is a graph of complex modulus and phase angle versus temperature for a formulation used in the invention (using C3 microgel);

FIG. 31 is a graph of complex modulus and phase angle versus temperature for a formulation used in the invention (using C2 microgel);

FIG. 32 is a graph of viscosity against temperature for a formulation used in the invention (using microgels D1, D2 and D3);

FIG. 33 is a graph of viscosity against temperature for a formulation used in the invention (using microgels D1, D2 and D3);

FIG. 34 is a graph of viscosity against temperature for a formulation used in the invention (using microgel D3);

FIG. 35 is a graph of complex modulus and phase angle versus temperature for a formulation used in the invention (using D3 microgel);

FIG. 36 is a graph of viscosity against temperature for a formulation used in the invention (using microgels E1, E2 and E3); and

FIG. 37 is a graph of viscosity against temperature for a formulation used in the invention (using microgels E1, E2 and E3).

### DETAILED DESCRIPTION OF THE INVENTION

The present invention relates to stimulus-responsive discrete polymer particles, particulates and dispersions, suspensions or formulations thereof in an aqueous carrier fluid (e.g. water), such as hydrophilic or aqueous microgels, which are characterised as having controlled rheology-stimulus profiles, and to methods of controlling the rheology-stimulus profiles and rheological behaviours of stimulus-responsive discrete polymer particle-containing formulations.

The formulations used in the invention, which comprise discrete stimulus-responsive crosslinked polymeric particles in aqueous medium, which polymeric particles comprise a copolymer of at least a first stimulus-responsive polymer-forming monomer and a second polymer-forming monomer having a weak acid functionality, and optionally an acid-neutralising agent or pH adjustment agent, have rheological behaviour that varies across a range of values of the stimulus (e.g. temperature), the rheology-stimulus profile, which may be controlled by controlling the portion of the second polymer-forming monomer in the polymeric particles and optionally the portion of weak acid functionality in the resulting polymeric particles that is neutralised. Formulations having a desired rheology-stimulus profile may be prepared having a certain proportion of second polymer and optionally a certain portion of neutralised acid functionality.

The method used in the invention comprises controlling the rheology-stimulus profile of a stimulus-responsive formulation of an aqueous dispersion or suspension of discrete stimulus-responsive crosslinked polymer particles in aqueous medium, which crosslinked polymer particles comprise at least a first stimulus-responsive polymer-forming monomer, by co-polymerising with the first stimulus-responsive polymer-forming monomer a second polymer forming monomer having weak acid functionality, preferably in an amount to achieve a desired rheological behaviour profile across a range of stimulus values. Optionally, the method may further comprise one or more of: controlling the ratio of second polymer-forming monomer to first stimulus-responsive polymer-forming monomer to be within a predefined range; controlling the concentration of stimulus-responsive polymer particles dispersed in the aqueous medium, preferably to within a pre-defined range; providing to the formulation an acid-neutralising agent or pH adjustment agent in an amount to neutralise a portion of the weak acid functionality of the polymeric particles, preferably within a predefined range; and controlling the hydrodynamic diameter of the polymeric particles in their collapsed state, preferably to be within certain pre-defined parameters.

By aqueous dispersion or suspension or aqueous medium, it is meant that the solvent or carrier fluid comprises water in an amount of at least 50% by weight, preferably at least 75%, more preferably at least 90% and still more preferably at least 98%. A purely aqueous composition comprises a carrier fluid or medium consisting essentially of water.

The discrete stimulus-responsive polymeric particles of the stimulus-responsive formulation may be any suitable crosslinked polymer composition which forms discrete particles in the aqueous carrier fluid or medium (as opposed, for example, to a linear polymer material with significant multiple inter-polymer crosslinking) which polymer particulate material is compatible with the aqueous medium and preferably also any other components of the formulation. The stimulus-responsive polymer particles are preferably characterised as water-swellable stimulus-responsive polymer particles.

By stimulus-responsive particles and stimulus-responsive formulation (such as aqueous microgels) it is meant, preferably that the polymer particles or particulate material (or microgels) are switchable whereby the carrier-swellability (e.g. water-swellability) is adjustable, due to some external change (switching function), between a first swollen (i.e. carrier-retaining) state and a second unswollen (or collapsed) state. This first swollen (carrier-retaining) state may also be referred to as a ‘good solvent’ regime, whereby conditions are such that the carrier is a good solvent for the polymer particles causing them to retain solvent and swell.

In response to an external stimulus, such as temperature change, the suspension of polymeric particles of the polymeric ‘microgels’ or formulation may change from a first rheological state to a second rheological state. This change in rheological states of the suspension of stimulus-responsive particles equates to differences in size or shape or more particularly volume, represented by equivalent spherical diameter of the particles, the term equivalent spherical diameter being used in its art-recognized sense in recognition of particles that are not necessarily spherical.

The stimulus to which the stimulus-responsive particles are responsive may be any suitable internal or external stimulus, such as changes in light exposure, electrical or magnetic charge, or temperature. Preferably the stimulus is temperature, whereby the particles are thermally responsive. The formulations and discrete polymer particles used in the invention herein described and in embodiments thereof are preferably temperature responsive. In embodiments described hereinafter, where particles/formulations are referred to as stimulus-responsive, it is preferred that they are temperature-responsive. Where particles/formulations are referred to as temperature-responsive, it should be considered that where the context allows, the stimulus may be another external stimulus other than temperature, but is in any case preferably temperature.

Accordingly, in the preferred embodiment wherein the stimulus-responsive particles are temperature (or thermally)-responsive (i.e. the switching function is temperature), the temperatures at which switching occurs may be referred to as the ‘switching temperature’. The ‘switching temperature’ can be fine-tuned to adapt to exterior conditions by appropriate selection of the stimulus-responsive polymer particles. Optionally, this can be done either by inclusion/exclusion of a co-monomer with appropriate hydrophilic or hydrophobic character in the main stimulus-responsive polymer fragment or by inclusion or adjustment of concentration of other components in the composition, such as a surfactant. However it is desirable that most of the volume change from a lower to a higher volume induced by the temperature change, and most of any change in properties, for example viscosity, occurs over as small a temperature range as possible.

The stimulus-responsive particles, especially thermally-sensitive (temperature-responsive) polymers, may be prepared, for example, by polymerisation (or co-polymerisation) of monomers which will impart thermal sensitivity (i.e. the first stimulus-responsive polymer-forming monomer), such as N-alkylacrylamides, such as N-ethyl-acrylamide and N-isopropylacrylamide, hereinafter NIPAM, N-alkyl-methacrylamides, such as N-ethylmethacrylamide and N-isopropyl-methacrylamide, vinylcaprolactam, vinyl methylethers, partially-substituted vinylalcohols, ethylene oxide-modified benzamide, N-acryloylpyrrolidone, N-acryloylpiperidine, N-vinylisobutyramide, hydroxyalkylacrylates, such as hydroxyethylacrylate, hydroxyalkylmethacrylates, such as hydroxyethyl-methacrylate, and copolymers thereof, by methods known in the art. Accordingly, it is preferred that the first stimulus-responsive polymer forming monomer is selected from at least one of the above monomers.

For instance, Varghese et al. (Journal Chemical Physics, 112, 6, 3063-3070, 2000) describe a thermally-sensitive co-polymer composed of a critical molar ratio of a highly hydrophilic co-monomer (2-acrylamido-2-methyl propane sulfonic acid) and a highly hydrophobic co-monomer (N-tertiary butylacrylamide), although neither of the homopolymers is thermally-sensitive.

Another class of thermally-sensitive polymers is composed of copolymers of 2-(2-methoxyethoxy)ethyl methacrylate and oligo(ethylene glycol) methacrylate, as described by Lutz et al. in Journal of the American Chemical Society, 2006, 13046-13047.

Preferably, a first stimulus-responsive polymer-forming monomer is an N-alkylacrylamides, most preferably N-isopropylacrylamide (NIPAM).

The formulation used in the invention and discrete polymer particles for use in the invention may be controlled so as to determine a certain rheology-stimulus (preferably rheology-temperature) profile by copolymerising the first stimulus-responsive polymer-forming monomer (preferably NIPAM) with a second polymer-forming monomer having a weak acid functionality. Preferably, the second polymer-forming monomer is an organic acid having a carboxylic acid functionality. Preferably, the second polymer forming monomer is a weak acid, which optionally may have a pKa of 3.5 or higher, more preferably 3.8 or higher still more preferably 4 or higher (e.g. 4 to 6, more preferably 4 to 5), still more preferably 4.1 to 4.5 and most preferably a pKa of 4.2 to 4.3.

Preferably, the second polymer is selected from substituted or unsubstituted alkanoic acids or substituted or unsubstituted alkenoic acids. The second polymer may be selected from one or more of formic acid, acetic acid, glyolic acid, acrylic acid, methacrylic acid, propanoic acid, hydroxypropanic acid, 3-chloropropanoic acid, 2-methylpropanoic acid, butanoic acid, 3-chlorobutanic acid, 4-chlorobutanoic acid, 3-hydroxybutanoic acid, 4-hydroxybutanoic acid, 2-methylbutanoic acid, 3-methylbutanoic acid, 4-aminobutanoic acid, butenoic acid, 3-butenoic acid, pentanoic acid, hexanoic acid, heptanoic acid, octanoic acid, adipic acid, heptanedioic acid, octanedioic acid, cyclohexanecarboxylic acid, adiparnic acid, trimethylacetic acid, ascorbic acid, citric acid, glyceric acid, barbituric acid, alloxonic acid, acetoacetic acid, succinic acid, methylsuccinic acid or gluteric acid.

More preferably, according to one embodiment, the second polymer is a substituted or unsubstituted acrylic acid such as acrylic acid or methacrylic acid. Most preferably the second polymer is acrylic acid.

The copolymer may be a block copolymer, a regular (e.g. alternating or periodic copolymer) or a random copolymer. Most preferably, the copolymer is a random copolymer.

In a preferred embodiment, the discrete polymer particle comprises a copolymer of NIPAM and acrylic acid or methacrylic acid, preferably a random copolymer and most preferably consists essentially of (e.g. consists of) a copolymer of NIPAM and acrylic acid or methacrylic acid.

According to the present invention, the proportion of second polymer-forming monomer to first stimulus-responsive polymer-forming monomer may be selected to control the rheology-stimulus (e.g. rheology-temperature) profile.

Preferably, the stimulus-responsive formulation comprises an acid-neutralising agent or pH adjustment agent in an amount to neutralise a portion of the weak acid functionality (provided by the weak acid second polymer-forming monomer) of the polymeric particles. It should be noted that the acid-neutralising agent or pH adjustment agent should not be provided in such an amount as to neutralise all of the weak acid functionality.

Preferably, the formulation and method used in the invention are such that proportion of second polymer-forming monomer to first stimulus-responsive polymer-forming monomer and the portion of weak acid functionality neutralised may be selected to control the rheology-stimulus (e.g. rheology-temperature) profile.

A rheology-stimulus profile or rheology-temperature profile of a formulation according to the invention may be considered a profile of rheological behaviour of the formulation over a temperature (or stimulus) range. The rheological behaviour may be plotted against temperature to visually represent the profile, in which case the rheological behaviour plotted may be selected from viscosity or complex modulus (G*) or other rheological behavioural measure, where G* is a measure of the ratio of amplitude or applied stress to the amplitude of measured strain in a forced oscillation experiment, as defined hereinafter. Preferably, the rheological behaviour plotted against temperature to form a rheology-temperature profile is viscosity. The rheology-temperature profile may alternatively be represented by a plot of, for example, viscosity or complex modulus (G*) against stress at several temperatures.

Preferably, the rheology-temperature profile of the formulation used in the invention is controlled to have a first thermal range in which the formulation has a first rheological profile or behaviour and either or both of a second thermal range and a third thermal range, wherein the second thermal range is at higher temperature than the first thermal range and the third thermal range is at lower temperature than the first thermal range. Within the second thermal range according to this embodiment, the formulation exhibits a second rheological profile or behaviour and within the third thermal range the formulation exhibits a third rheological profile or behaviour.

A rheological behaviour which may be characteristic of a formulation within a first, second or third thermal range may be any suitable definable, reproducible or predictable rheological behaviour. It may be a behaviour that varies consistently or predictable with temperature or it may represent a rheological property that is measurable and lies between two parameters or it may simply be the behaviour observable along a range in which the ranges are separated by characteristic changes in rheological behaviour or are otherwise defined.

In a preferred embodiment, the rheological behaviour may be considered to be gel-like behaviour or liquid-like behaviour whereby a first, second or third thermal range is a range of temperature in which the formulation exhibits either a gel-like behaviour or a liquid-like behaviour.

Most preferably, the first thermal range is a range of temperature in which the formulation exhibits liquid-like behaviour.

Preferably, the second thermal range exhibits a different rheological behaviour than the first thermal range and the third thermal range exhibits a different rheological behaviour than the second thermal range.

In a preferred embodiment, the formulation comprises a first thermal range exhibiting liquid-like behaviour, a second thermal range exhibiting gel-like behaviour and a third thermal range exhibiting gel-like behaviour.

By gel-like behaviour, it is meant that the formulation behaves viscoelastically as if it were a gel, or yield stress material, which preferably is a formulation that has an elastic response to applied stress at low strain amplitude in a forced oscillation test. Preferably, a formulation is considered to exhibit gel-like behaviour when the value of the phase angle is below 15° when measured at 1 rad·s⁻¹ (or when elastic modulus G′ is greater than or equal to 3.5× the viscous modulus G″).

By liquid-like behaviour, it is meant that the formulation behaves viscoelastically as if it were a liquid. Preferably, a formulation is considered to exhibit liquid-like behaviour when the value of the phase angle is 15° or greater when measured at 1 rad·s⁻¹ (or when elastic modulus G′ is less than 3.5× the viscous modulus G″).

Preferably, a formulation having a thermal range in which it exhibits gel-like behaviour has a viscosity at low stress (0.04 Pa) of 10 Pa·s or greater, optionally 1 Pa·s or greater or 0.1 Pa·s or greater and a formulation having a thermal range in which it exhibits liquid-like behaviour has a viscosity at low stress (0.04 Pa) of 0.01 Pa·s or less, preferably 0.005 Pa·s or less.

Preferably a ‘thermal range’ as described above is a range of temperature in which the rheological behaviour is consistent or predictable, e.g. viscosity reduces with temperature, or viscosity increases with temperature or viscosity doesn't significantly change with temperature. If the change in rheological behaviour (such as viscosity) with change in temperature alters (e.g. the viscosity starts to increase with increasing temperature instead of decreasing with increasing temperature), the temperature at which that occurs may be considered a transition point or transition range, which separates two thermal ranges.

Viscosity and rheological behaviour in formulations such as those used in the invention may be measured in continuous shear flow or forced oscillation experiments.

In continuous shear flow, a constant stress, σ, is applied and the resultant shear rate, \dot{γ}, determined. The viscosity η is the ratio of the shear stress to shear rate:

$$η = \frac{σ}{\dot{γ}}$$

In rheology, a common alternative to constant shear measurements are forced oscillation experiments, which allow the structure of the sample to be studied without the large deformation that occurs under continuous shear. Rather than applying a constant force to the bob in one direction, a sinusoidally oscillating force is applied and the resulting strain is monitored. In order to analyse the data meaningfully, the sample should be probed in the linear viscoelastic regime, that is to say, at strains that are insufficient to disrupt the structure of the sample.

On applying an oscillating stress σ with angular frequency ω,

σ=σₒ sin ωt

the strain γ will begin to oscillate at the same frequency, but will lag behind by an amount defined by the phase angle δ,

γ=γₒ sin(ωt+δ)

where σₒ and γₒ are the amplitudes of the respective signals. If the sample is an elastic solid, the phase angle will be 0° and the waves will be exactly in phase. Conversely, if the phase angle is 90°, then the waves will be out of phase, and the sample is a viscous liquid. The relationship between the phase angle and the in phase (elastic or storage) modulus G′ and the out of phase (viscous or loss) modulus G″ can be written as

$$tan δ = \frac{{G}^{″}}{{G}^{′}}$$

For a viscoelastic solid G′>>G″ (δ→0°), and for a viscoelastic liquid, G″→G′ (δ→90°).

The complex modulus G* is the ratio of the amplitude of the applied stress σₒ to the amplitude of the measured strain γₒ thus,

$${G}^{*} = \frac{{σ}_{o}}{{γ}_{o}}$$

The complex modulus is so named since it combines the two physical parts of phase and amplitude in the usual complex representation, and is defined as

G*=G′+iG″

and so the magnitude of G* is given by

|G*|=(G′²+G″²)^{1/2}

Preferably, the rheological profile over a temperature range in a thermal range as defined above is thermally reversible—i.e. the rheological profile is similar in a heating and cooling cycle.

The precise switching temperature may be adjusted by methods known in the art.

In all cases it is desirable that the switching point from one rheological state to another or transitioning from one rheological behaviour or thermal range to another occurs over as small as a range as possible.

Preferably, the formulation used in the invention comprises in an aqueous medium discrete stimulus-responsive (e.g. temperature-responsive) particles in a concentration in the range 0.5% by weight (wt %) of the formulation to 10% by weight of the formulation, more preferably 1 wt % to 8 wt %, still more preferably 2 wt % to 6 wt %, still more preferably 2.5 wt % to 5 wt % and most preferably 4 wt %.

The formulation used in the invention preferably comprises discrete stimulus-responsive (preferably temperature-responsive) polymer particles as herein described (i.e. which comprise a first stimulus-responsive polymer forming monomer and a second polymer-forming monomer having weak acid functionality) wherein the molar ratio of first stimulus-responsive polymer to second polymer-forming monomer present is preferably in the range 80:20 to 99.5:0.5, more preferably 90:10 to 99:1, still more preferably 95:5. Preferably, the second polymer-forming monomer is present in an amount of 0.5 to 10 mol % of the polymer content of the particles, more preferably in the range 1 mol % to 7 mol % and still more preferably 2 mol % to 6 mol % and most preferably 5 mol %. Preferably the first stimulus-responsive polymer forming monomer is present in an amount of at least 80 mol % of the polymer in the particles, more preferably at least 90 mol %, still more preferably in the range 90 mol % to 99 mol %, still more preferably in the range 94 mol % to 98 mol % and most preferably 95 mol %.

Ideally, the discrete stimulus-responsive polymer particles consist essentially of a first stimulus-responsive polymer-forming monomer and a second polymer-forming monomer, which are preferably provided in a molar ratio in the range 90:10 to 99:1 and most preferably 95:5.

The formulation used in the invention is provided with an acid neutralising agent or pH adjustment agent in an amount to neutralise a portion of the weak acid functionality of the polymeric particles. Preferably, the acid-neutralising agent or pH adjustment agent is provided in an amount (or is provided in the formulation at a concentration) to ionise from 5% to 95% of the weak acid functionality, preferably from 50% to 90% and more preferably from 60% to 85%.

The acid-neutralising or pH adjustment agent may be any component that is capable of neutralising the weak acid functionality of the discrete polymer particles, e.g. an organic or inorganic base. Preferably the acid-neutralising agent or pH adjustment agent is an inorganic base, such as sodium hydroxide or potassium hydroxide. Preferably the inorganic base (e.g. sodium hydroxide) is provided to the formulation in a concentration of from 0.5 mM to 20 mM, more preferably 1 mM to 10 mM and still more preferably up to 5 mM, e.g. 2 mM or 4 mM.

The discrete stimulus-responsive polymer particles of the formulation used in the invention may be any suitable size and optionally may have a collapsed particle size (equivalent spherical diameter) of less than 80 nm or a collapsed particles size of 80 nm or greater. The size (of collapsed particles) may be selected according to the desired utility of the formulation. For example, for use as an inkjet ink medium, the formulation preferably has particles with a size (in the collapsed state) of 500 nm or less, preferably 300 nm or less, more preferably 150 nm or less and most preferably in the range 50 to 100 nm (and preferably at least 80 nm), in order to allow passage of the particles in their collapsed state through an inkjet printhead. The constraints on particle size for flexographic printing are less stringent and for providing structural colour, the particle sizes would be expected to be significantly larger. Preferably, for formulations having a gel-liquid-gel rheology-temperature profile, the discrete stimulus-responsive polymer particles are formed with a particle size of 80 nm or greater (since microgels below 80 nm tend not to gel at low temperatures, i.e. down to 10° C.).

The particles used in the invention are preferably prepared by random copolymerisation by addition of a polymerisation initiator to a vessel containing a the polymer-forming monomers of the particles along with a surfactant and a cross-linking agent. The polymerisation reaction is typically carried out in deionised aqueous solution purged with nitrogen and heated to 70° C. for several hours (e.g. 6 hours, for a 1 L reaction size).

The number of monomers units in the stimulus-responsive polymer particles may typically vary from 20 to 1500 k. For example the number of monomer units in poly(NIPAM) is from 200-500 k and for poly-vinylcaprolactam is from 20 to 1500 k.

The preferred relative proportions of polymer-forming monomer are discussed above.

A polymerization reaction for the formation of stimulus-responsive particles according to the present invention may be initiated using a charged or chargeable initiator species, such as, for example, a salt of the persulfate anion, especially potassium persulfate, or with a neutral initiator species if a charged or chargeable co-monomer species is incorporated in the preparation. The initiation of the radical polymerization may then triggered by the decomposition of the initiatior resulting from exposure to heat or to light. In the case of initiation using heat, a reduced temperature can be used by combining the initiator compound, such as potassium persulfate, with an accelerator compound, such as sodium metabisulfite. Preferably, the initiator is added to a heated reaction mixture containing the monomers to be polymerised.

Surfactants or mixtures of surfactants may be used in the polymerization reaction for the synthesis of the stimulus-responsive polymer particles to control the size of the particles (synthesis surfactants). The surfactants may be anionic: for example, sodium dodecylsulfate, hereinafter SDS, salts of fatty acids, such as salts of dialkylsulfosuccinic acid, especially sodium dioctyl sulfosuccinate, hereinafter AOT, salts of alkyl and aryl sulfonates and salts of tri-chain amphiphilic compounds, such as sodium trialkyl sulfo-tricarballylates. The anionic surfactants may also comprise hydrophilic non-ionic functionalities, such as ethylene oxide or hydroxyl groups. They may be nonionic: for example, polyoxyethylene alkyl ethers, acetylene diols and their derivatives, alkylthiopolyacrylamides, copolymers of polyoxyethylene and polyoxypropylene, alcohol alkoxylates, sugar-based derivatives; they may be cationic, such as alkyl amines, quaternary ammonium salts; or they may be amphoteric: for example, betaines. However the surfactant should normally be selected such that it is either uncharged (non-ionic), has no overall charge (amphoteric or zwitterionic surfactant) or matches the charge of the stimulus-responsive polymer used. The preferred surfactants include acetylene diol derivatives, such as Surfynol® 465 (available from Air Products Corp.) or alcohol ethoxylates such as Tergitol® 15-S-5 (available from Dow Chemical company), but the most preferred are SDS and AOT. The surfactants may be incorporated in the initial reaction mixture with a molar ratio up to 3 mol % of the total monomer amount, preferably 0.5 to 2.5 mol %, more preferably 0.7 to 1.5 mol %.

A cross-linker is preferably included in the preparation of the stimulus-responsive polymer particles to maintain the shape of the polymer particle, although too high a concentration of crosslinker may inhibit the swellability of the polymer. If there is an alternative way of maintaining particle architecture, such as a core particle in a polymer shell, it may be possible in some instances, however, to exclude a crosslinker.

Suitable cross-linkers for this purpose include, for example, any materials which will link functional groups between polymer chains and the skilled artisan would choose a cross-linker suitable for the materials being used e.g. via condensation chemistry. Examples of suitable cross-linkers include N,N′-methylenebisacrylamide, N,N′-ethylenebisacrylamide, dihydroxyethylene bisacrylamide, N,N′-bis-acryloylpiperazine, ethyleneglycol dimethacrylate, glycerin triacrylate, divinylbenzene, vinylsulfone or carbodiimides. The cross-linker may also be an oligomer with functional groups which can undergo condensation with appropriate functional groups on the polymer. The cross-linking material is used for partial cross-linking the polymer. The particles can also be cross-linked, for example, by heating or ionizing radiation, depending on the functional groups in the polymer.

The quantity of cross-linker used, if present, with respect to the major type of the monomer should normally be in the range of 0.01-20 mol % of cross-linker to monomer, preferably 0.05 to 10 mol % of cross-linker to monomer, more preferably 0.05 to 7 mol % and more preferably 1 to 5 mol % of cross-linker to monomer although not specifically limited thereto. This is especially the case where the polymer formed comprises N-alkylacrylamide. The quantity of cross-linker will determine the cross-linking density of the polymer particles and may adjust, for example, the swelling degree and/or phase transition temperature, of the polymer.

Optionally, the stimulus-responsive polymer particle may be in the form of a core/shell particle wherein the polymer forms a shell that surrounds a core. The interaction with the core can be of a chemical nature such that the polymer would be grafted onto the surface of the core by bonds which are preferably covalent. However the interaction can be of a physical nature, for example the core can be encapsulated inside the switchable polymer shell, the stability of the core/shell assemblage being obtained by the cross-linking of the shell material. The core could be functionalized or non-functionalized polystyrene, latex, silica, titania, a hollow sphere, magnetic or conductive particles or could comprise an organic pigment. In the case of a core/shell particle, typically the equivalent spherical diameter of the core would be in the range of 0.005-0.15 μm and the switchable shell grafted on to the surface of the core would be sufficient in the contracted state to provide a core/shell particle with such a diameter as would be desired (e.g. in the case of an inkjet ink considerably less than the diameter of the inkjet printhead orifice in order to prevent blockage and enable passage through an orifice or restriction as above). Thus the core/shell particle would have a particle equivalent diameter as stated above for a non-core/shell particle. Preferably, however, the particles are not core/shell particles of this type.

In another aspect of the invention and preferred embodiments thereof, there is provided a discrete polymer particle comprising a stimulus-responsive monomer (such as NIPAM) and further comprising one or more further features of polymer particles as described herein.

The stimulus-responsive discrete polymer particles and particle-containing formulations used in the invention can be used as components or carrier/binding media in many applications, for example, in inks, particularly in inkjet inks, for example, for ‘drop-on-demand’ or ‘continuous’ inkjet printing, in conventional printing inks, for example, for lithography, flexography, gravure or screen printing, in ‘inks’ or ‘toners’ for electrophotography, in fluids for microfluidic devices, in cosmetics, in medical applications, for example, for drug delivery, in photonic applications, or in any of the applications that capitalise on the responsive nature of the material and the property changes this brings. The formulations of the present invention provide the particular benefit of controllable rheology along a temperature range and, in its preferred embodiment, a formulation that is liquid-like at processing temperatures in order to facilitate mixing, spraying etc, gel-like at lower temperatures (e.g. storage temperatures, thereby inhibiting precipitation, creaming and sedimentation) and gel-like at higher temperatures (whereby drying can be facilitated without coalescence or loss of material).

There is further provided, therefore, a functional formulation comprising a stimulus-responsive polymer particle formulation as defined above and a functional material.

A ‘functional material’ is a material that provides a particular desired mechanical, electrical, magnetic or optical property. As used herein the term ‘functional material’ preferably refers to a colorant, such as a pigment, which is dispersed in a carrier fluid, or a dye, dispersed and/or dissolved in the carrier fluid, magnetic particles (e.g. for barcoding), conducting or semi-conducting particles, quantum dots, metal oxide, wax, a drug compound for drug-delivery formulations, an agrochemical compound, e.g. a pesticide, or a cleaning agent. Preferably the functional material, however, is a pigment dispersed in the carrier fluid or a dye dispersed and/or dissolved in the carrier fluid.

Optionally, the quantity of functional material, which may be dependent upon the nature of the functional material or the application, may be from 0.5 wt % to 50 wt %, more preferably from 2 wt % to 30 wt %.

In one particular embodiment of a functional formulation described above, the functional material may be a colorant, such as a pigment or a dye and the formulation may be a paint or an ink (such as an inkjet ink). Such an inkjet ink may be suitable for printing onto low energy substrate surfaces or impermeable or hydrophobic substrates whereby drying may be facilitated by causing the ink to gel at high temperature.

In another embodiment, the functional material may be a cosmetic component, whereby a cosmetic may be applied in liquid state but the rheology change on application to enhance sticking.

In a yet further embodiment, the functional material may be an agrochemical such as a fertiliser, whereby mixing and spraying may be conducted at a certain processing temperature in the liquid-like state, whilst on application, the formulation gels to enable sticking to a crop and is retained there without being washed off.

The invention will now be described with reference to the following examples, which are however, in no way to be considered limiting thereof.

### EXAMPLES

The following examples illustrate the use of a second monomer and added base to control the rheological properties and rheological properties over temperature of a temperature responsive polymer particulate formulation in accordance with the invention.

In each example the monomer, surfactant and cross-linking agent and co-monomer, when initially present, were added to a double-walled glass reactor equipped with a mechanical stirrer a condenser and nitrogen purge; the mixture was heated to reaction temperature before addition of the polymerization initiator. The N-isopropyl-acrylamide monomer, hereinafter NIPAM, the surfactant bis(2-ethylhexyl)-sulfosuccinate sodium salt (sodium dioctyl sulfosuccinate), hereinafter AOT, and the cross-linking agent methylenebisacrylamide, hereinafter BIS, were all obtainable from Sigma-Aldrich™ and the surfactant sodium dodecyl sulfate, hereinafter SDS, was obtainable from Fluka. Other co-monomers such as acrylic acid (AAc) or methacryic acid (MAAc) were obtained from Sigma-Aldrich,™ Fluka and Acros as required. In the following examples, the proportion of NIPAM and co-monomers is expressed as molar %, and the molar % of cross-linking agent or surfactant is the molar ratio of the cross-linking agent or surfactant to the total monomer content.

The particle size of the suspension of the thermally-sensitive particles was in each case measured by photon correlation spectroscopy, PCS, and determined with a Malvern ZetasizerNano ZS™. A dilute sample of thermally-sensitive particles was obtained from the purified sample and was diluted with milli-Q water, a typical sample concentration being 0.05 wt %. Samples were equilibrated at each temperature for 10 minutes and then the size was measured 5 times, such that the total time at each temperature was approximately 25 minutes. The results quoted are the mean of the measurements. The volumetric swelling ratio is the cubic ratio between the hydrodynamic diameter measured at 20° C. and the hydrodynamic diameter measured at 50° C.

The rheology of the microgels (formulations) was studied in at concentrations between 2 and 4 wt % on Bohlin CS50™ or Malvern Gemini NanoHR™ rheometers with a bob and cup C2.3/26 geometry in continuous and oscillatory shear flow. Both instruments are controlled-stress rheometers, and work by applying a constant user-defined stress to the bob, and measuring the resulting angular deflection or speed of rotation of the bob. Sample temperature was maintained by controlling the temperature of the exterior of the cup with circulating water (CS50) or a peltier system (Gemini™). Experiments were carried out either at constant temperature (after at least 5 minutes thermal equilibration) or under a temperature ramp of 0.5° C.min⁻¹.

In continuous shear flow a constant stress, σ, is applied and the resultant shear rate, \dot{γ}, determined. The viscosity η is the ratio of the shear stress to shear rate:

$$η = \frac{σ}{\dot{γ}}$$

In rheology, a common alternative to constant shear measurements are forced oscillation experiments, which allow the structure of the sample to be studied without the large deformation that occurs under continuous shear. Rather than applying a constant force to the bob in one direction, a sinusoidally oscillating force is applied and the resulting strain is monitored. In order to analyse the data meaningfully, the sample should be probed in the linear viscoelastic regime, that is to say, at strains that are insufficient to disrupt the structure of the sample.

On applying an oscillating stress σ with angular frequency ω,

σ=σₒ sin ωt

the strain γ will begin to oscillate at the same frequency, but will lag behind by an amount defined by the phase angle δ,

γ=γₒ sin(ωt+δ)

where σₒ and γₒ are the amplitudes of the respective signals. If the sample is an elastic solid, the phase angle will be 0° and the waves will be exactly in phase. Conversely, if the phase angle is 90°, then the waves will be out of phase, and the sample is a viscous liquid. The relationship between the phase angle and the in phase (elastic or storage) modulus G′ and the out of phase (viscous or loss) modulus G″ can be written as

$$tan δ = \frac{{G}^{″}}{{G}^{′}}$$

For a viscoelastic solid G′>>G″ (δ→0°), and for a viscoelastic liquid, G″→G′ (δ→90°).

The complex modulus G*, which is the ratio of the amplitude of the applied stress σₒ, to the amplitude of the measured strain γₒ thus,

$${G}^{*} = \frac{{σ}_{o}}{{γ}_{o}}$$

The complex modulus is so named since it combines the two physical parts of phase and amplitude in the usual complex representation, and is defined as

G*=G′+iG″

and so the magnitude of G* is given by

|G*|=(G′²+G″²)^{1/2}

A gelled sample has at low strain amplitude an elastic response to applied stress. For convenience, the sample will be taken to be in the gelled state when the value of the phase angle is below 15° measured at 1 rad·s⁻¹, which corresponds to G′≧3.5G″. For the materials described here, the viscosity at low stress (<0.1 Pa) starts to rise strongly (>10 Pa·s) as the phase angle falls towards 15°.

### P1

### Comparative Example 1

PNIPAM Microgel Prepared in the Presence of SDS with a Collapsed Particle Size Larger than 80 Nm.

This PNIPAM microgel was a water swellable cross-linked polymer prepared according to the method described in WO-A-02008/075049, using SDS as a surfactant. 15.8 g N-isopropylacrylamide (NIPAM), 0.303 g BIS and 0.305 g SDS were added to a 1 L reactor. 900 ml Milli Q water was added, the mixture warmed to 40° C. and purged with nitrogen for 30 min., while being stirred at 200 rpm. The solution was then heated to 70° C. and 0.602 g potassium persulfate initiator (dissolved in 20 ml deionized water which had been purged with nitrogen) was added quickly to the reactor. The mixture was stirred at 200 rpm at 70° C. for 6 h under nitrogen. The reaction mixture rapidly became opalescent, then white. The heating was switched off and the mixture left to cool to room temperature. The reaction yielded a white dispersion which was filtered, then dialyzed until the conductivity of the permeate was less than 5 μS/cm.

Cross-linking agent/monomer molar ratio 0.014.

Surfactant/monomer molar ratio 0.007

Particle hydrodynamic diameter 288 nm at 20° C.; 124 nm at 50° C.

Volumetric swelling ratio 12.6.

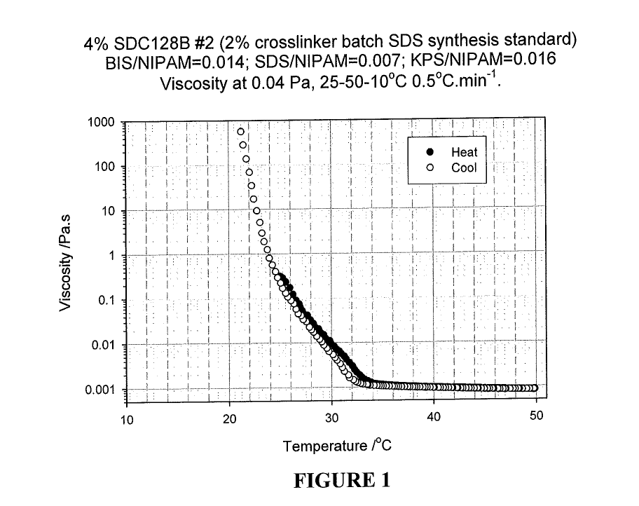

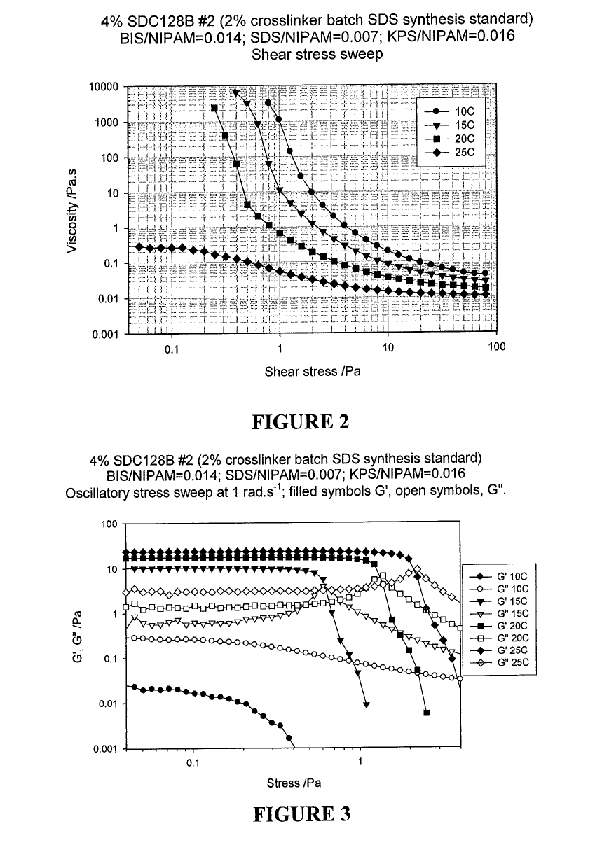

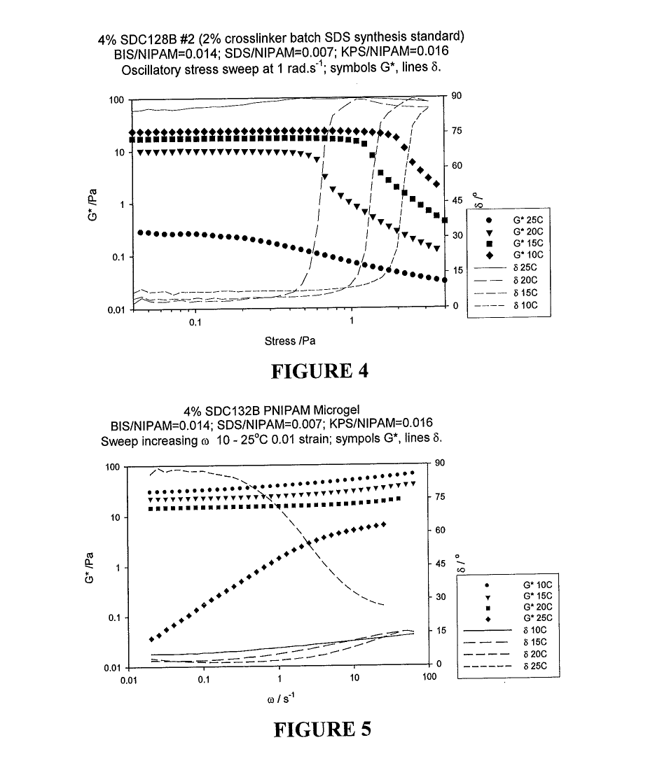

The rheology of the homo-pNIPAM microgel P1 at 4 wt % shows strong temperature dependence below 32° C., as can be seen in FIG. 1 [which shows viscosity at low stress (0.04 Pa) of P1 microgel (no carboxylic acid monomer) at 4 wt %; heat and cool 25-50-10° C. at 0.5° C.min⁻¹]. Above 32° C., the viscosity is close to that of water. At 25° C., the viscosity is typical of a viscoelastic fluid suspension of soft particles in that it has a Newtonian (i.e. constant viscosity) plateau at low stress and shear thins at higher stress [see FIG. 2, which shows viscosity of P1 microgel (no carboxylic acid monomer) at 4 wt % as a function of applied stress at different temperatures]. However, as the temperature falls to 20° C. and below, the viscosity at low shear increases very sharply (FIG. 1 and FIG. 2), to an extent that it is not possible to measure a plateau at the accessible shear (here 0.04 Pa). Measurements in oscillatory shear demonstrate that the sample is elastic at these low temperatures (G′>>G″), although application of higher shear (typically strains >0.1) leads to a “melting” of the structure (G″>G′ at high stress). The P1 samples at 4% are gelled or yield stress materials at low temperature. The behaviour with oscillatory shear is described in terms of complex modulus (G*) and phase angle (δ) in FIG. 4 [which shows complex modulus (G*) and phase angle (δ) of P1 microgel (no carboxylic acid monomer) at 4 wt % in oscillatory shear flow at 1 rad·s⁻¹ as a function of applied stress at different temperatures] and the behaviour of the gelled samples (≦20° C.) is characterised by much higher G* values and lower δ values at low shear. As stress increases the value of G* and δ remain constant until the strain is approximately 0.1 and then G* falls and δ increases sharply as behaviour switches from solid to liquid like. At low temperatures and low strains, the values of G* and δ exhibit little frequency dependence, which is characteristic of a solid-like system [FIG. 5, which shows complex modulus (G*) and phase angle (δ) of P1 microgel (no carboxylic acid monomer) at 4 wt % in oscillatory shear flow as a function of frequency with stress controlled to give a strain of 0.01]. At 25° C., the value of δ approaches 90° and there is a strong frequency dependence in G* at low frequency.

### P2

### Comparative Example 2

PNIPAM Microgel Prepared in the Presence of AOT with a Collapsed Particle Size Smaller than 80 nm.

This PNIPAM microgel was a water swellable cross-linked polymer prepared using AOT as a surfactant. 79 g NIPAM, 1.5 g BIS and 4.5 g AOT were added to a 6 L reactor. 4400 ml milli Q water was added, the mixture warmed to 40° C. and purged with nitrogen for 1 h, while being stirred at 200 rpm. The solution was then heated to 70° C. and equilibrated for 90 min. and 3 g potassium persulfate initiator (dissolved in 50 ml milli Q water which had been purged with nitrogen) was added quickly to the reactor. The mixture was stirred at 200 rpm at 70° C. for 6 h under nitrogen. The reaction mixture rapidly became opalescent, then white. The heating was switched off and the mixture left to cool to room temperature. The reaction yielded a transparent dispersion which was filtered, then dialyzed until the conductivity of the permeate was less than 5 μS/cm.

Cross-linking agent/monomer molar ratio 0.014.

Surfactant/monomer molar ratio 0.014

Particle hydrodynamic diameter 137 nm at 20° C.; 59 nm at 50° C.

Volumetric swelling ratio 12.7.

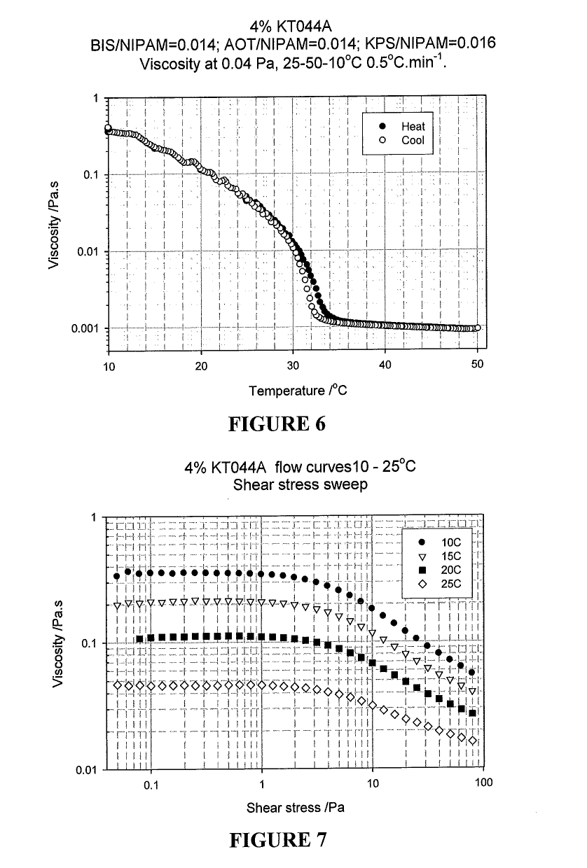

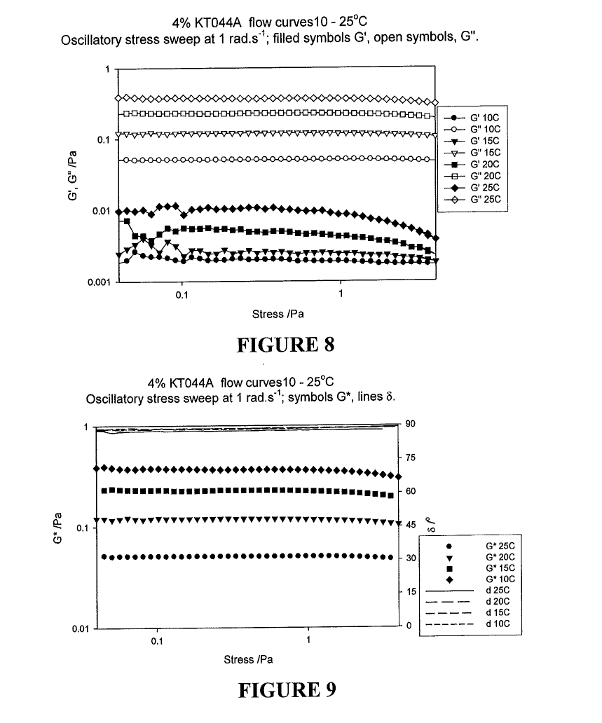

The smaller homo-PNIPAM microgel P2 does show the same rheological behaviour at high temperature—water like above 32° C. and viscosity increase as the temperature falls, as can be seen in FIG. 6 [which shows viscosity at low stress (0.04 Pa) of P2 microgel (no carboxylic acid monomer) at 4 wt %; heat and cool 25-50-10° C. at 0.5° C.min⁻¹] However, this smaller microgel sample does not develop elastic properties even at temperatures as low as 10° C. There is a clear Newtonian plateau [FIG. 7, which shows viscosity of P2 microgel (no carboxylic acid monomer) at 4 wt % as a function of applied stress at different temperatures] and the value of G″>>G′ [FIG. 8—storage (G′) and loss (G″) moduli of P2 microgel (no carboxylic acid monomer) at 4 wt % in oscillatory shear flow at 1 rad·s⁻¹ as a function of applied stress at different temperatures] and δ close to 90° [FIG. 9—Complex modulus (G*) and phase angle (δ) of P2 microgel (no carboxylic acid monomer) at 4 wt % in oscillatory shear flow at 1 rad·s⁻¹ as a function of applied stress at different temperatures] with little stress dependence in oscillatory flow

### P3

### Comparative Example 3

### PNIPAM Linear Polymer Prepared in the Absence of Surfactant and Cross-Linker Agent.

This PNIPAM linear polymer was prepared according to a typical method, in the absence of cross-linker and surfactant. The reaction temperature is maintained below the lower critical solution temperature (LCST) of PNIPAM and the polymerisation is initiated by a redox initiator in the presence of an accelerator. 22.6 g NIPAM and 180 ml milli Q water were added to a 1 L reactor. The mixture is maintained at room temperature (25-27° C.) and purged with nitrogen for 1 h, while being stirred at 200 rpm. 0580 g ammonium persulfate initiator and 0.330 g sodium metabisulfite accelerator (dissolved in 20 ml milli Q water) were added quickly to the reactor. The mixture was stirred at 200 rpm at 30° C. for 18 h under nitrogen. The reaction mixture rapidly became white then transparent. The reaction yielded a transparent dispersion which was filtered, then dialyzed until the conductivity of the permeate was less than 5 μS/cm.

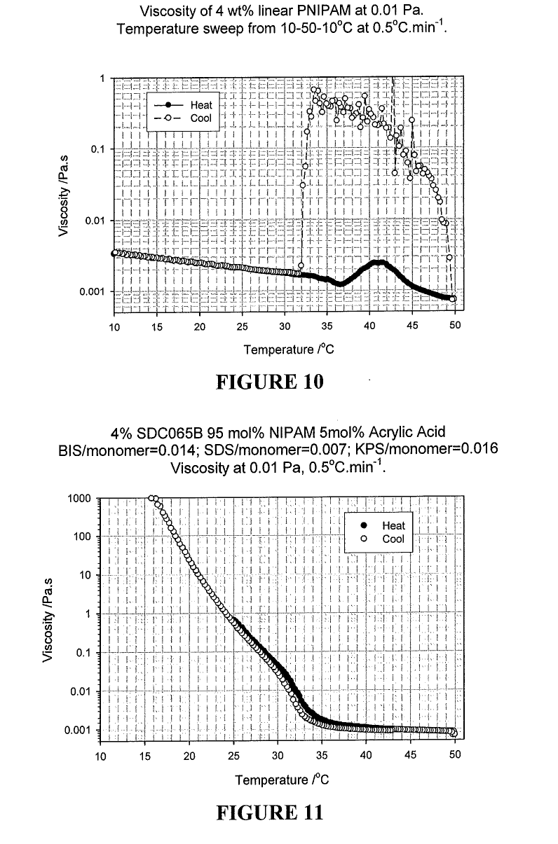

This sample has much lower viscosity at low temperature (<4 mPa·s at 10° C.) and shows instability at high temperature, as can be seen from FIG. 10 [which shows viscosity at low stress (0.01 Pa) of P3 linear polymer (no crosslinker nor carboxylic acid monomer) at 4 wt %; heat and cool 10-50-10° C. at 0.5° C.min⁻¹)].

### Example A1

PNIPAM/PAAc Co-Polymer Microgel, Prepared in the Presence of SDS with a Collapsed Size Larger than 80 nm

This PNIPAM/PAAc microgel was a water swellable cross-linked polymer prepared using SDS as a surfactant in a batch process with the acrylic acid co-monomer present in the reactor prior to the polymerisation initiation, leading to a random co-polymer with co-monomer distribution related to the reactivity ratio of co-monomers. 11.9 g N-isopropylacrylamide (NIPAM), 0.407 g acrylic acid, 0.241 g BIS and 0.245 g SDS were added to a 1 L reactor. 450 ml Milli Q water was added, the mixture warmed to 40° C. and purged with nitrogen for 45 min., while being stirred at 200 rpm. The solution was then heated to 70° C. and 0.501 g potassium persulfate initiator (dissolved in 80 ml deionized water which had been purged with nitrogen) was added quickly to the reactor. The mixture was stirred at 200 rpm at 70° C. for 6 h under nitrogen. The reaction mixture rapidly became opalescent, then white. The heating was switched off and the mixture left to cool to room temperature. The reaction yielded a white dispersion which was filtered, then dialyzed until the conductivity of the permeate was less than 5 μS/cm.

95 molar % NIPAM and 5 molar % AAc

Cross-linking agent/total monomer molar ratio 0.014.

Surfactant/total monomer molar ratio 0.008.

Particle hydrodynamic diameter 395 nm at 20° C.; 88 nm at 50° C.

Volumetric swelling ratio 90.4.

VPTT=38° C.

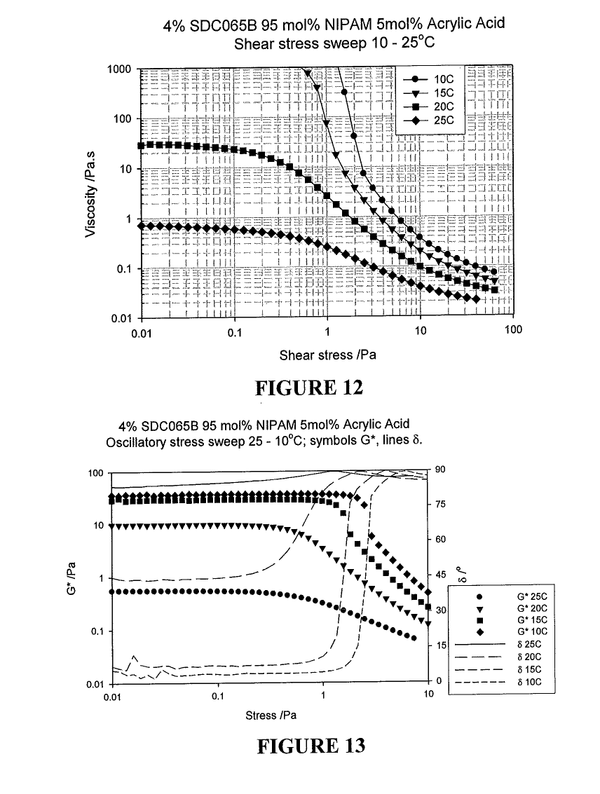

The rheology of microgel A1 in the absence of added base lies between that of the microgels without carboxylic acid monomers (P1 and P2). The viscosity diverges at low stress on cooling below 15° C. while it is close to that of water from the slightly higher temperature of 35° C. (reflecting the inclusion of a non “switchable” hydrophilic monomer at 5 mol % in place of the NIPAM) [FIG. 11, which shows viscosity at low stress (0.01 Pa) of A1 microgel (95:5 m/e ratio NIPAM:AAc) at 4 wt %; heat and cool 25-50-10° C. at 0.5° C.min⁻¹]. Flow curves are consistent with yield stress behaviour at ≦15° C., as can be seen in FIG. 12 [which shows viscosity of A1 microgel (95:5 m/e ratio NIPAM:AAc) at 4 wt % as a function of applied stress at different temperatures] and FIG. 13 [which shows complex modulus (G*) and phase angle (δ) of A1 microgel (95:5 m/e ratio NIPAM:AAc) at 4 wt % in oscillatory shear flow at 1 rad·s⁻¹ as a function of applied stress at different temperatures].

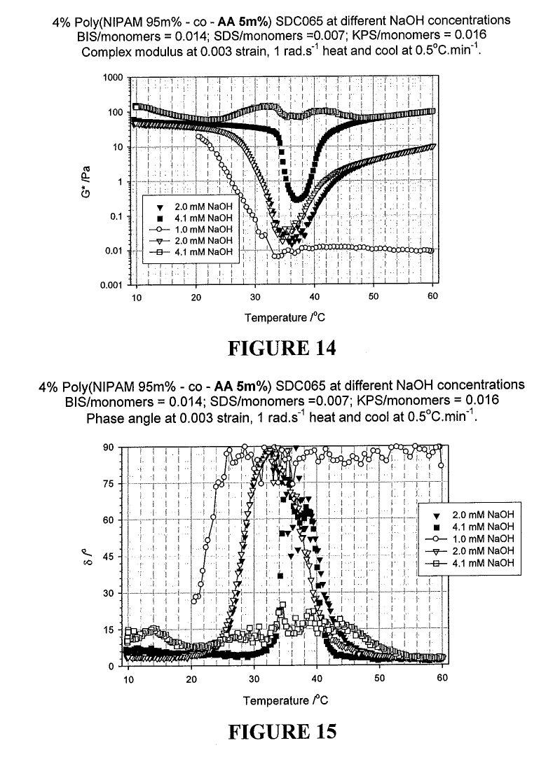

On addition of base, however, the rheological profile starts to change, as shown in temperature sweeps at constant radial frequency with low strain (stress adjusted to give 0.003 strain) as complex modulus [FIG. 14—complex modulus (G*) of A1 microgel (95:5 m/e ratio NIPAM:AAc) at 4 wt % with different concentrations of NaOH in oscillatory shear flow at 1 rad·s⁻¹ and low stress (0.04 Pa for 1 mM and 0.003 strain for 2 and 4 mM NaOH) on heating and cooling at 0.5° C.min⁻¹] and phase angle [FIG. 15—phase angle (δ) of A1 microgel (95:5 m/e ratio NIPAM:AAc) at 4 wt % with different concentrations of NaOH in oscillatory shear flow at 1 rad·s⁻¹ and low stress (0.04 Pa for 1 mM and 0.003 strain for 2 and 4 mM NaOH) on heating and cooling at 0.5° C. min⁻¹]. At 1 mM NaOH, the samples are increasingly fluid above 20° C., with a switch to constant low viscosity above 33° C. At 2 mM NaOH, the sample is a gel at low temperature and high temperature but fluid at intermediate temperatures (δ>75° 30-36° C.).

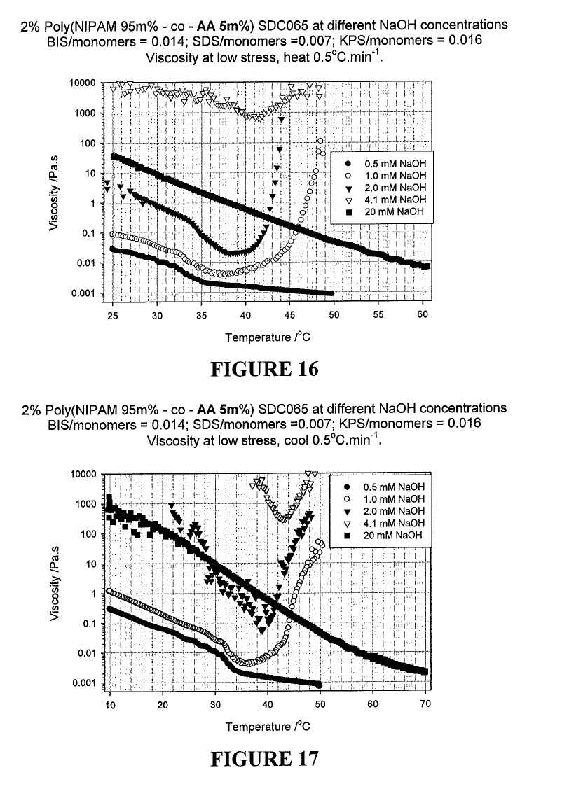

The microgel copolymer A1 at a reduced concentration of 2 wt % also shows reversible gelation on heating at 1 and 2 mM added NaOH [FIG. 16—viscosity at low stress (0.04 Pa) of A1 microgel (95:5 m/e ratio NIPAM:AAc) at 2 wt % and different concentrations of NaOH. Heat from 25° C. at 0.5° C.min⁻¹] and [FIG. 17—viscosity at low stress (0.04 Pa) of A1 microgel (95:5 m/e ratio NIPAM:AAc) at 2 wt % and different concentrations of NaOH; cool to 10° C. at 0.5° C.min⁻¹]. At 20 mM NaOH, the transition temperature is above 60° C., so gelation behaviour was not pursued for this composition. At 0.5 mM NaOH, there is little change from the homopolymer microgel.

This illustrates how the proportion of acid neutralisation agent may be utilised to control rheological profile. By addition of certain concentration of base to a 2% aqueous dispersion of 95:5 NIPAM:acrylic acid polymeric particles, the rheology temperature profile can be controlled to define a first thermal range (˜32° C. to ˜40° C.) in which the formulation is liquid-like and a second and third thermal range either side thereof in which the formulation is gel-like.

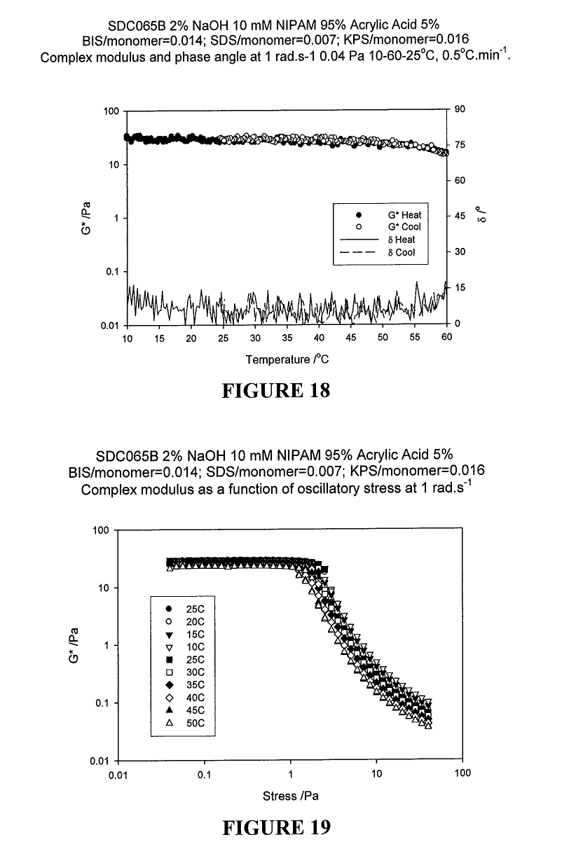

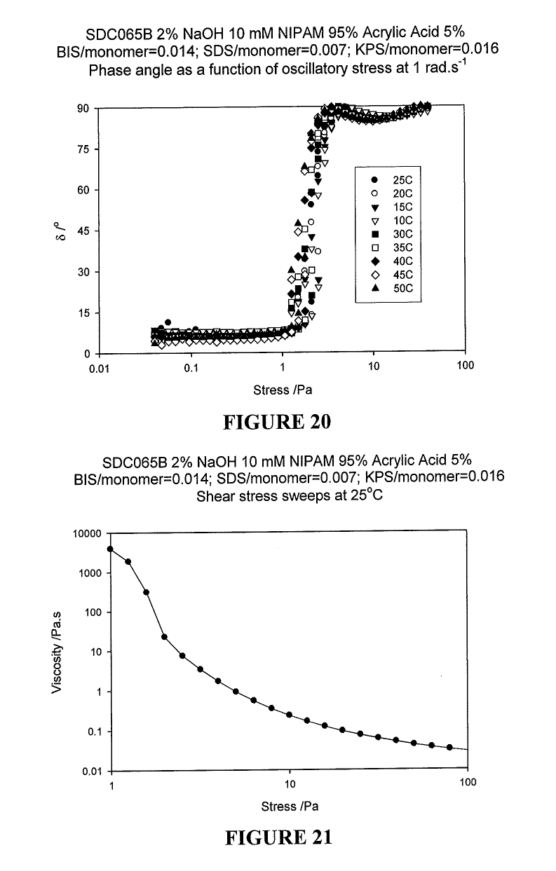

At an intermediate concentration of base (10 mM NaOH), the copolymer microgel A1 forms a clear gel with rheological properties independent of temperature. The complex modulus and phase angle are shown in FIG. 18 [which shows complex modulus (G*) and phase angle (δ) of A1 microgel (95:5 m/e ratio NIPAM:AAc) at 2 wt % and 10 mM NaOH in oscillatory shear flow at 1 rad·s⁻¹ and 0.04 Pa as a function of temperature over the range 10-60-25° C. at 0.5° C.min⁻¹], while stress sweep studies at 1 rad·s⁻¹ [FIG. 19—complex modulus (G*) of A1 microgel (95:5 m/e ratio NIPAM:AAc) at 2 wt % and 10 mM NaOH in oscillatory shear flow at 1 rad·s⁻¹ as a function of applied stress at different temperatures] and [FIG. 20—phase angle (δ) of A1 microgel (95:5 m/e ratio NIPAM:AAc) at 2 wt % and 10 mM NaOH in oscillatory shear flow at 1 rad·s⁻¹ as a function of applied stress at different temperatures] show a remarkable lack of temperature dependence. This gel can be reversibly broken and maintain its properties over a very wide range of temperature. The viscosity in shear flow falls sharply from a stress just above 1 Pa [FIG. 21—viscosity of A1 microgel (95:5 m/e ratio NIPAM:AAc) at 2 wt % and 10 mM NaOH in shear flow as a function of applied stress at 25° C.; viscosity values above 1000 Pa·s (below 1.5 Pa, here) have low steady state value].

### Example B1

PNIPAM/PMAAc Co-Polymer Microgel, Prepared in the Presence of SDS with a Collapsed Size Larger than 80 nm

This pNIPAM/pMAAc microgel was a water swellable cross-linked polymer prepared using SDS as a surfactant in a batch process with the methacrylic acid co-monomer present in the reactor prior to the polymerisation initiation, leading to a random co-polymer with co-monomer distribution related to the reactivity ratio of co-monomers. 7.5 g N-isopropylacrylamide (NIPAM), 0.301 g methacrylic acid, 0.150 g BIS and 0.150 g SDS were added to a 1 L reactor. 450 ml Milli Q water was added, the mixture warmed to 40° C. and purged with nitrogen for 30 min., while being stirred at 200 rpm. The solution was then heated to 70° C. and 0.300 g potassium persulfate initiator (dissolved in 50 ml deionized water which had been purged with nitrogen) was added quickly to the reactor. The mixture was stirred at 200 rpm at 70° C. for 6 h under nitrogen. The reaction mixture rapidly became opalescent, then white. The heating was switched off and the mixture left to cool to room temperature. The reaction yielded a white dispersion which was filtered, then dialyzed until the conductivity of the permeate was less than 5 μS/cm.

95 molar % NIPAM and 5 molar % MAAc

Cross-linking agent/total monomer molar ratio 0.015.

Surfactant/total monomer molar ratio 0.007.

Particle hydrodynamic diameter 417 nm at 20° C.; 189 nm at 50° C.

Volumetric swelling ratio 10.7.

VPTT=32° C.

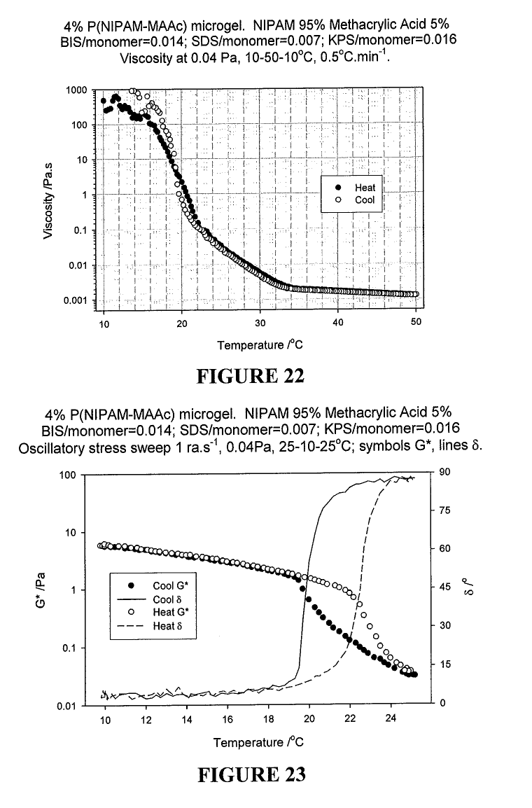

The copolymer microgel B1 in the absence of base shows high viscosity at low shear and low temperature but water-like behaviour above 33° C., as can be seen in FIG. 22 [which shows viscosity of B1 microgel microgel (95:5 m/e ratio NIPAM:MAAc) at 4 wt % with no added base in steady shear flow at 0.04 Pa on heating and cooling at 0.5° C.min⁻¹]. In low-amplitude oscillatory shear at 1 rad·s⁻¹, the

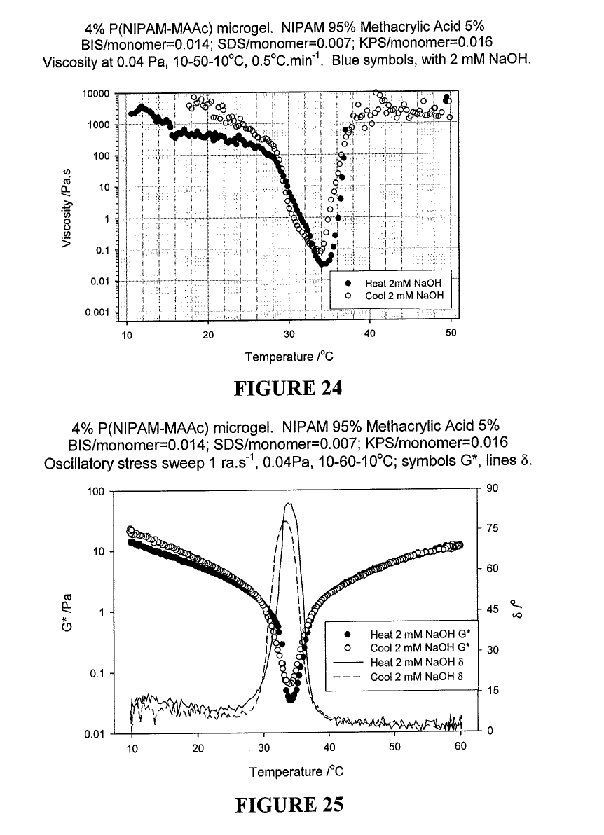

4 wt % suspension is gels below 20° C. [FIG. 23—complex modulus (G*) and phase angle (δ) of B1 microgel (95:5 m/e ratio NIPAM:MAAc) at 4 wt % with 2 mM NaOH in oscillatory shear flow at 1 rad·s⁻¹ and 0.04 Pa as a function of temperature over the range 25-10-25° C. at 0.5° C.min⁻¹]. However, on addition of 2 mM NaOH, the copolymer microgel B1 suspension is gelled at low and high temperatures but is fluid over the range 32-35° C. [FIG. 24—viscosity of B1 microgel microgel (95:5 m/e ratio NIPAM:MAAc) at 4 wt % with 2 mM NaOH in steady shear flow at 0.04 Pa on heating and cooling at 0.5° C.min⁻¹] and [FIG. 25—complex modulus (G*) and phase angle (δ) of B1 microgel microgel (95:5 m/e ratio NIPAM:MAAc) at 4 wt % with 2 mM NaOH in oscillatory shear flow at 1 rad·s⁻¹ and 0.04 Pa as a function of temperature over the range 24-10-25° C. at 0.5° C.min⁻¹].

### Examples C1, C2 and C3

PNIPAM/PAAc Co-Polymer Microgels, Prepared in the Presence of AOT with a Collapsed Size Smaller than 80 nm

These PNIPAM/PAAc microgels were a water swellable cross-linked polymer prepared using AOT as a surfactant in a batch process with the acrylic acid co-monomer present in the reactor prior to the polymerisation initiation, leading to a random co-polymer with co-monomer distribution related to the reactivity ratio of co-monomers. X g N-isopropylacrylamide (NIPAM), Y g acrylic acid, 0.150 g BIS and 0.450 g AOT were added to a 1 L reactor. 450 ml Milli Q water was added, the mixture warmed to 40° C. and purged with nitrogen for 30 min., while being stirred at 200 rpm. X and Y amounts are summarized in Table 1. The solution was then heated to 70° C. and 0.300 g potassium persulfate initiator (dissolved in 12 ml deionized water which had been purged with nitrogen) was added quickly to the reactor. The mixture was stirred at 200 rpm at 70° C. for 6 h under nitrogen. The reaction mixture rapidly became opalescent, then white. The heating was switched off and the mixture left to cool to room temperature. The reaction yielded a white dispersion which was filtered, then dialyzed until the conductivity of the permeate was less than 5 μS/cm.

Cross-linking agent/total monomer molar ratio 0.015.

Surfactant/total monomer molar ratio 0.014.

TABLE 1

| | | | | Diameter | Volume |
|---|---|---|---|---|---|
| | NIPAM/AAc | X (g) | Y (g) | at 20/50° C. | Swelling |
| Polymer | m %/m % | NIPAM | AAc | (nm) | ratio |
| C1 | 99/1 | 7.87 | 0.053 | 155/50.2 | 28.7 |
| C2 | 97/3 | 7.70 | 0.165 | 145/47.3 | 27.3 |
| C3 | 95/5 | 7.58 | 0.270 | 235/55.4 | 77 |

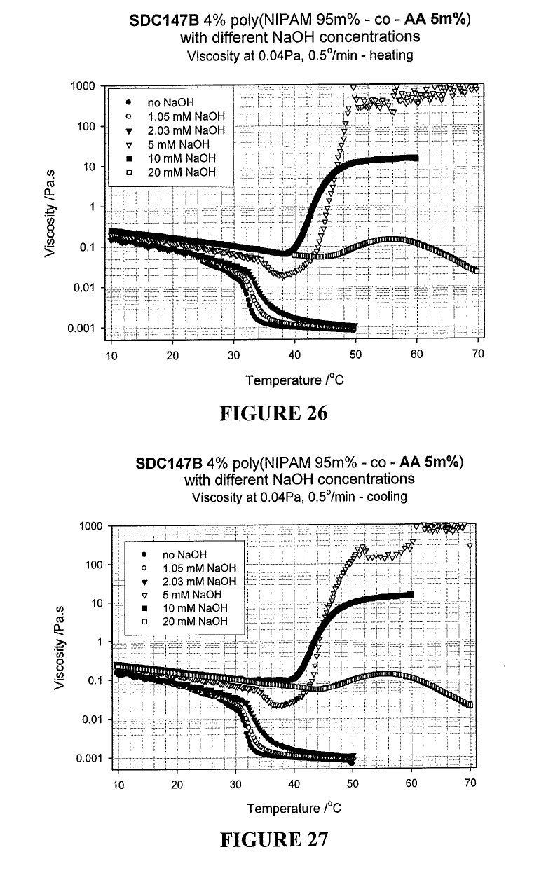

The copolymer microgels C1-3 do not gel at low temperature at 4 wt %. In the absence of added base, the rheology is similar to that of homopolymer microgel P2. On addition of base to the copolymer C3, the rheological behaviour changes, particularly at temperatures above 30° C.—see [FIG. 26—viscosity at low stress (0.04 Pa) of C3 microgel (95:5 m/e ratio NIPAM:AAc) at 4 wt % and different concentrations of NaOH; heat at 0.5° C.min⁻¹] and [FIG. 27—viscosity at low stress (0.04 Pa) of C3 microgel (95:5 m/e ratio NIPAM:AAc) at 4 wt % and different concentrations of NaOH; cool at 0.5° C.min⁻¹]. First, the fall in viscosity from 30° C. reduces and the switching temperature increases (to 2 mM NaOH) then at 5 mM NaOH, the viscosity passes through a minimum at 38° C. before rising sharply and gelling. The viscosity rises but to a lesser extent at 10 mM NaOH and shows only a very small maximum (near 55° C.) at 20 mM NaOH.

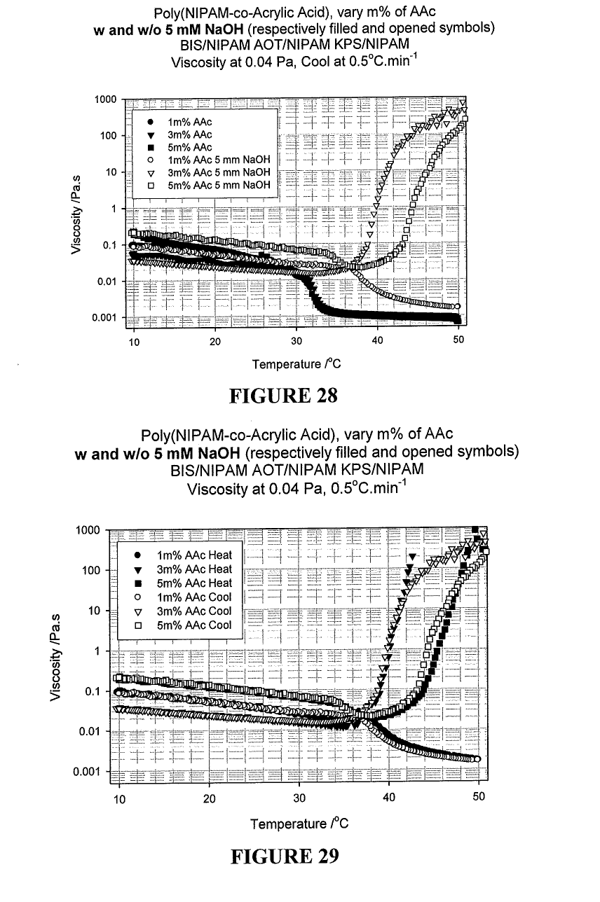

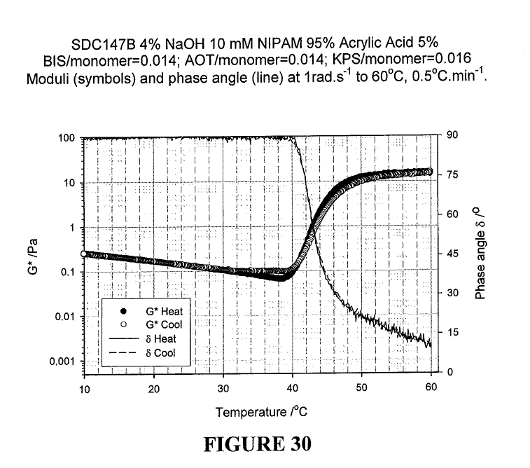

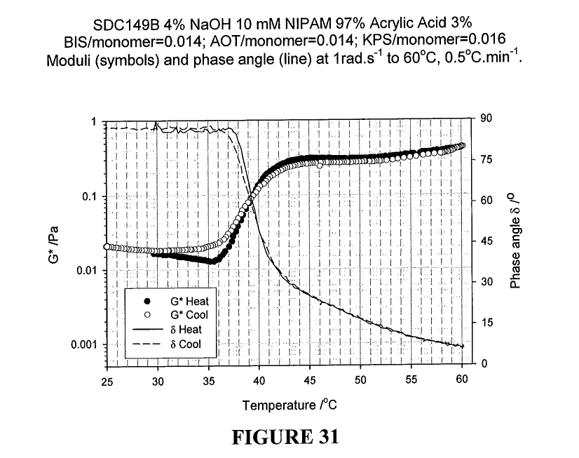

Behaviour of the copolymers C1-3 at 4 wt % in the presence and absence of 5 mM NaOH is shown in FIG. 28 [which shows viscosity at low stress (0.04 Pa) of C1, C2 and C3 microgels (1, 3 and 5 m % AAc) at 4 wt % and 5 mM NaOH; cool at 0.5° C.min⁻¹] and FIG. 29 [which shows viscosity at low stress (0.04 Pa) of C1, C2 and C3 microgels (1, 3 and 5 m % AAc) at 4 wt % and 5 mM NaOH. 10-50-10° C. at 0.5° C.min⁻¹]. The suspensions are fluid at low temperature and in the absence of base exhibit water-like viscosity above 34° C. In the presence of base, the switching temperature of C1 is increased but there is no thermogelation. The copolymers with higher levels of acrylic acid show reversible thermpgelation at elevated temperatures. The gelation temperature can be controlled by the concentration of acrylic acid comonomer. The plots in oscillatory shear demonstrate the reversible liquid-solid transition on heating for C3 in the presence of 5 mM and 10 mM NaOH, see FIG. 30 [which shows complex modulus (G*) and phase angle (δ) of C3 microgel microgel (95:5 mole ratio NIPAM:AAc) at 4 wt % with 10 mM NaOH in oscillatory shear flow at 1 rad·s⁻¹ and 0.04 Pa as a function of temperature over the range 30-60-25° C. at 0.5° C.min⁻¹] and FIG. 31 [which shows complex modulus (G*) and phase angle (δ) of C2 microgel microgel (97:3 mole ratio NIPAM:AAc) at 4 wt % with 10 mM NaOH in oscillatory shear flow at 1 rad·s⁻¹ and 0.04 Pa as a function of temperature over the range 30-60-25° C. at 0.5° C.min⁻¹].

### Examples D1, D2 and D3

PNIPAM/PMAAc Co-Polymer Microgels, Prepared in the Presence of AOT with a Collapsed Size Smaller than 80 nm

These PNIPAM/PMAAc microgels were a water swellable cross-linked polymer prepared using AOT as a surfactant in a batch process with the methacrylic acid co-monomer present in the reactor prior to the polymerisation initiation, leading to a random co-polymer with co-monomer distribution related to the reactivity ratio of co-monomers. X g N-isopropylacrylamide (NIPAM), Y ml methacrylic acid, 0.150 g BIS and 0.450 g AOT were added to a 1 L reactor. 450 ml Milli Q water was added, the mixture warmed to 40° C. and purged with nitrogen for 30 min., while being stirred at 200 rpm. X and Y amounts are summarized in TABLE 2. The solution was then heated to 70° C. and 0.300 g potassium persulfate initiator (dissolved in 12 ml deionized water which had been purged with nitrogen) was added quickly to the reactor. The mixture was stirred at 200 rpm at 70° C. for 6 h under nitrogen. The reaction mixture rapidly became opalescent, then white. The heating was switched off and the mixture left to cool to room temperature. The reaction yielded a white dispersion which was filtered, then dialyzed until the conductivity of the permeate was less than 5 μS/cm.

Cross-linking agent/total monomer molar ratio 0.015.

Surfactant/total monomer molar ratio 0.014.

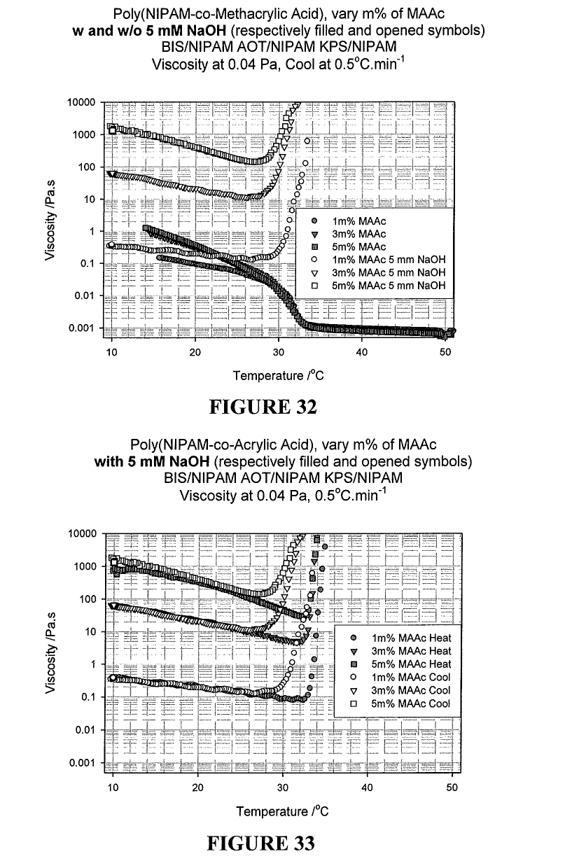

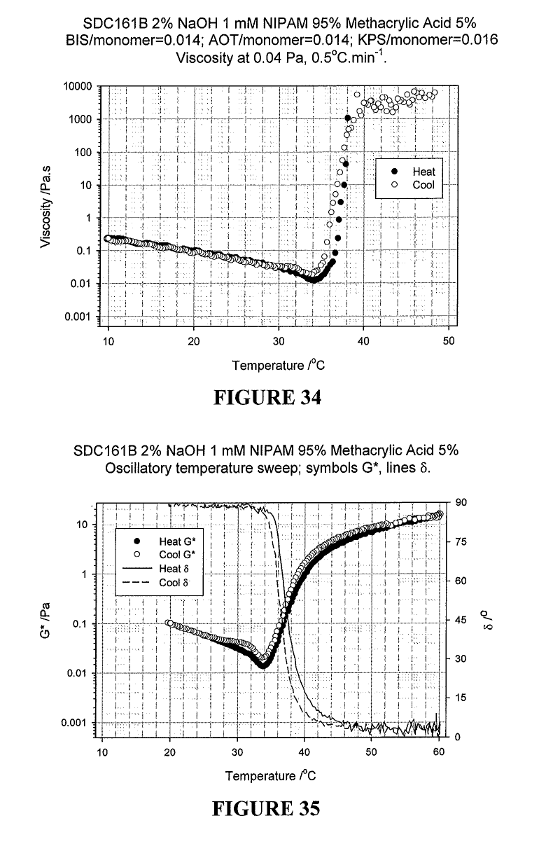

The copolymer microgels D1-D3 at 4 wt % in the absence of added base have similar viscosity at low temperature to the homo-PNIPAM microgel B and water-like viscosity above 34° C. In the presence of 5 mM NaOH, the viscosity increases at low temperature with increasing carboxylic acid content and gels near 35° C., as can be seen in FIG. 32 [which shows viscosity at low stress of D1-D3 microgels (1, 3 and 5 mol % MAAc) at 4 wt % and zero and 5 mM NaOH; cool at 0.5° C.min⁻¹; stress of 0.01 Pa (no base) and 0.04 Pa (5 mM NaOH)]. The gelation behaviour is reversible with temperature—see [FIG. 33—viscosity at low stress (0.04 Pa) of D1-D3 microgels (1, 3 and 5 mol % MAAc) at 4 wt % a and 5 mM NaOH; heat and cool at 0.5° C.min⁻¹]. On dilution to 2 wt %, D3 microgel exhibits reversible gelation close to 36° C. in the presence of just 1 mM NaOH [FIG. 34—viscosity at low stress (0.04 Pa) of D3 microgel (95:5 m/e ratio NIPAM:MAAc) at 2 wt % and 1 mM NaOH; cool at 0.5° C.min⁻¹] and [FIG. 35—complex modulus (G*) and phase angle (δ) of D3 microgel (95:5 m/e ratio NIPAM:MAAc) at 2 wt % and 1 mM NaOH. in oscillatory shear flow at 1 rad·s⁻¹ and 0.04 Pa as a function of temperature over the range 10-60-20° C. at 0.5° C.min⁻¹].

TABLE 2

| | | | | Diameter | Volume |
|---|---|---|---|---|---|
| | NIPAM/MAAc | X (g) | Y (ml) | at 20/50° C. | Swelling |
| Polymer | m %/m % | NIPAM | MAAc | (nm) | ratio |
| D1 | 99/1 | 8.02 | 0.060 | 162/56 | 28.4 |
| D2 | 97/3 | 7.82 | 0.181 | 194/67 | 24.3 |
| D3 | 95/5 | 7.67 | 0.302 | 248/75 | 37.4 |

### Examples E1, E2 and E3

PNIPAM/PFAc Co-Polymer Microgel, Prepared in the Presence of AOT with a Collapsed Size Smaller than 80 nm

This PNIPAM/PFAc microgel was a water swellable cross-linked polymer prepared using SDS as a surfactant in a batch process with the fumaric acid co-monomer present in the reactor prior to the polymerisation initiation, leading to a random co-polymer with co-monomer distribution related to the reactivity ratio of co-monomers. X g N-isopropylacrylamide (NIPAM), Y g fumaric acid, 0.150 g BIS and 0.450 g AOT were added to a 1 L reactor. 450 ml Milli Q water was added, the mixture warmed to 40° C. and purged with nitrogen for 30 min., while being stirred at 200 rpm. X and Y amounts are summarized in Table 3. The solution was then heated to 70° C. and 0.300 g potassium persulfate initiator (dissolved in 12 ml deionized water which had been purged with nitrogen) was added quickly to the reactor. The mixture was stirred at 200 rpm at 70° C. for 6 h under nitrogen. The reaction mixture rapidly became opalescent, then white. The heating was switched off and the mixture left to cool to room temperature. The reaction yielded a white dispersion which was filtered, then dialyzed until the conductivity of the permeate was less than 5 μS/cm.

Cross-linking agent/total monomer molar ratio 0.015.

Surfactant/total monomer molar ratio 0.014.

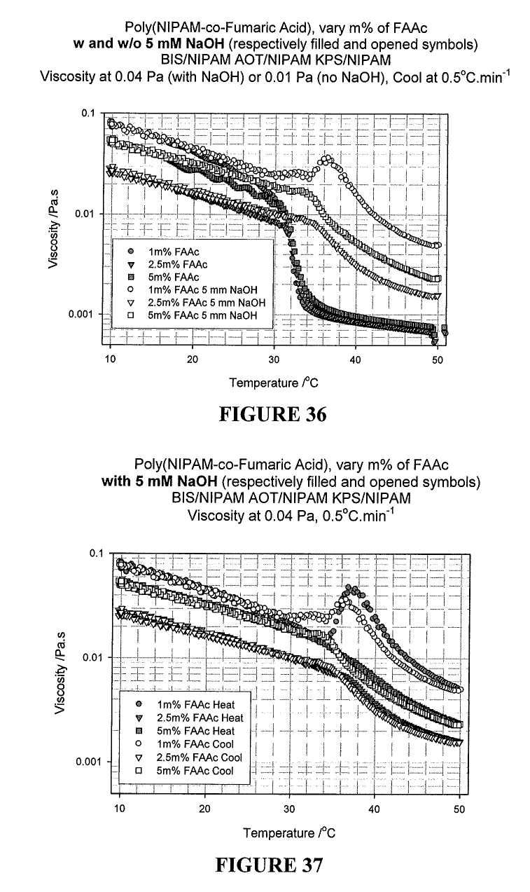

The copolymer microgels E1-3 at 4 wt % have lower viscosity at low temperature than homopolymer B1 [The 1% samples had sensible viscosity values of 5 mPa·s at 10° C.]. Addition of 5 mM NaOH leads to a small increase in the viscosity at low temperature and a significant increase in the switching temperature—the viscosity of 4% D1-3 does not quite show water-like behaviour even at 50° C.—see FIG. 36 [which shows viscosity at low stress (0.04 Pa) of E1-E3 microgels (1, 2.5 and 5 mol % FAAc) at 4 wt % and zero and 5 mM NaOH. Cool 50-10° C. at 0.5° C.min⁻¹]. Under these conditions, the copolymer microgels D1-3 do not show gelation on heating with the sample D3 showing a small maximum in viscosity at 37° C. [FIG. 37—viscosity at low stress (0.04 Pa) of D1-D3 microgels (1, 3 and 5 mol % MAAc) at 4 wt % and 5 mM NaOH. 10-50-10° C. at 0.5° C.min⁻¹].

TABLE 3

| | | | | Diameter | Volume |
|---|---|---|---|---|---|
| | NIPAM/MAAc | X (g) | Y (g) | at 20/50° C. | Swelling |
| Polymer | m %/m % | NIPAM | FAc | (nm) | ratio |
| E1 | 99/1 | 8.05 | 0.088 | 178/53 | 34.4 |
| E2 | 97.5/2.5 | 7.92 | 0.211 | 117/46 | 16.3 |
| E3 | 95/5 | 7.65 | 0.438 | 230/60 | 58.2 |

### Summary:

As can be seen from the examples described herein, the rheology and rheological properties of an aqueous formulation of temperature-responsive polymer particles can be varied and/or controlled by including in the particles as a random co-monomer a second monomer having weak acid functionality (e.g. acrylic acid or methacrylic acid) along side the temperature-responsive polymer-forming monomer (e.g. NIPAM) and/or by varying the concentration of base in the formulation thereby controlling the proportion of free weak acid functionalities. Thus a formulation can be prepared which demonstrates gel-like, liquid like and gel-like properties with increasing temperature.

1. A stimulus-responsive formulation comprising an aqueous dispersion or suspension of discrete stimulus-responsive crosslinked polymeric particles in aqueous medium, the polymeric particles comprising a co-polymer of at least a first stimulus-responsive polymer-forming monomer and a second polymer-forming monomer having a weak acid functionality, the formulation further comprising an acid-neutralizing agent or pH adjustment agent in an amount to neutralize a portion of the weak acid functionality of the polymeric particles.

2. A formulation as claimed in claim 1, wherein the stimulus is a change in temperature.

3. A formulation as claimed in claim 2, which comprises one or more of a concentration of polymeric particles dispersed in the formulation, a proportion of second polymer-forming monomer in the polymeric particles, and a concentration of acid-neutralizing agent or pH adjustment agent or a proportion of acid functionality neutralized selected such that the formulation demonstrates a desired rheology-stimulus profile.

4. A formulation as claimed in claim 3, which is temperature responsive, wherein the proportions are selected such that the formulation demonstrates a desired rheology-temperature profile.

5. A formulation as claimed in claim 4, wherein the desired rheology-temperature profile comprises a first thermal range in which the formulation has a first rheological profile or behavior, and either or both of a second thermal range and third thermal range, wherein the second thermal range is at higher temperature than the first thermal range and separated therefrom by a first transition point or first transition range and in which second thermal range the formulation has a second rheological profile or behavior, and wherein the third thermal range is at lower temperature than the first thermal range and separated therefrom by a second transition point or second transition range and in which third thermal range the formulation has a third rheological profile or behavior.

6. A formulation as claimed in claim 5, wherein the desired rheology-temperature profile comprises a first, second and third thermal range.

7. A formulation as claimed in claim 6, wherein the first thermal range is characterized by a rheological behavior that demonstrates liquid-like behavior, the second thermal range is characterized by a rheological behavior that demonstrates gel-like behavior and the third thermal range is characterized by a rheological behavior that demonstrates gel-like behavior.

8. A formulation as claimed in claim 1, which comprises the polymeric particles in a concentration in the range 1 weight % to 10 weight %.

9. A formulation as claimed in claim 1, wherein the second polymer-forming monomer is provided in an amount of 0.5 to 20 mol % of the total amount of monomer.

10. A formulation as claimed in claim 1, wherein the acid neutralizing agent is provided at a concentration to ionize from 50% to 90% of the weak acid functionality.

11. (canceled)

11. A formulation as claimed in claim 5, wherein the polymer particles are in a collapsed state in the first thermal range and in a swollen state in the second thermal range and wherein the diameter of the particles in the collapsed state is greater than 80 nm.

12. A formulation as claimed in claim 1, wherein the first stimulus-responsive polymer-forming monomer is selected from one or more of: N-alkylacrylamides, such as N-ethyl-acrylamide and N-isopropylacrylamide; N-alkyl-methacrylamides, such as N-ethyl-methacrylamide and N-isopropyl-methacrylamide; vinylcaprolactam; vinyl methylethers; partially-substituted vinylalcohols; ethylene oxide-modified benzamide; N-acryloylpyrrolidone; N-acryloylpiperidin; N-vinylisobutyramide; hydroxyalkylacrylates, such as hydroxyethylacrylate; and hydroxyalkylmethacrylates, such as hydroxyethyl-methacrylate.

13. A formulation as claimed in claim 12, wherein the first stimulus-responsive polymer-forming monomer is N-isopropylacrylamide.

14. A formulation as claimed in claim 1, wherein the second polymer-forming monomer is selected from substituted or unsubstituted alkanoic acids or alkenoic acids.

15. A formulation as claimed in claim 1, wherein the second polymer-forming monomer is acrylic acid or methacrylic acid.

16. A formulation as claimed in claim 1, wherein the polymeric particle comprises a random copolymer of N-ispropylacrylamide and acrylic acid.

17. A formulation as claimed in claim 1, which further comprises a functional material.

18. A formulation as claimed in claim 17, wherein the functional material is selected from a biologically active material, a colorant, a treatment agent, a fertilizing agent or crop treatment agent.

19. A formulation as claimed in claim 18, wherein the functional material is a biologically active material and the formulation is for controlled delivery of a biologically active material.

20. A formulation as claimed in claim 19, wherein the functional material is a colorant and the formulation is a printing ink.

22-31. (canceled)
